(19) United States
(12) Patent Application Publication
(10) Pub. No.: US 2026/0300273 A1
(43) Pub. Date: Oct. 1, 2026

(54) CONVERSATIONAL ARTIFICIAL INTELLIGENCE FOR UNDERSTANDING SOURCE CODE REPOSITORIES

(71) Applicant: Oracle International Corporation, Redwood Shores, CA (US)

(72) Inventors: Twinkle Arora, Hyderabad (IN); Adya Kiran, Udupi (IN); Krishna Karthik Jonnalagadda, Hyderabad (IN); Manish Kumar, Hyderabad (IN); Venugopal Machiraju, Hyderabad (IN); Javed Akhtar, Hyderabad (IN)

(73) Assignee: Oracle International Corporation, Redwood Shores, CA (US)

(21) Appl. No.: 19/091,068

(22) Filed: Mar. 26, 2025

(51) Int. Cl. G06F 16/242; G06F 16/22; G06F 16/248; G06F 16/901

(52) U.S. Cl. CPC G06F 16/243; G06F 16/2237; G06F 16/248; G06F 16/9024

(57) ABSTRACT

Techniques for using conversational artificial intelligence to understand and manage source code repositories in software development environments. In one aspect, a computer-implemented method is described that includes receiving an utterance concerning code in a codebase, generating an utterance vector embedding based on the utterance, executing a similarity search on a vector index by comparing the utterance vector embedding to vector embeddings stored in the vector index using a similarity metric and identifying relevant nodes in a graph-based representation of the codebase based on the comparing, executing, based on types of constructs associated with the relevant nodes, queries on a graph database to retrieve additional context associated with the relevant nodes, generating a prompt comprising the utterance, the relevant nodes, and the additional context associated with the relevant nodes, and generating, by a generative model, a response to the utterance based on the prompt.

### FIELD

The present disclosure relates generally to source code repositories, and more particularly, to techniques for using conversational artificial intelligence to understand and manage source code repositories in software development environments.

### BACKGROUND

Modern software development relies heavily on the use of source code repositories, which serve as centralized storage systems for managing and maintaining software code. These repositories are important for enabling collaboration among developers, tracking changes to code over time, and ensuring the integrity and security of software assets. Popular source code repository platforms, such as Git, Mercurial, and Subversion, have become integral tools for developers, providing features such as version control, branch management, and conflict resolution.

Source code repositories are typically accessed and used through a combination of command-line interfaces (CLI), graphical user interfaces (GUI), and integrated development environments (IDE). Developers interact with these repositories to perform a variety of tasks, including committing changes, merging branches, resolving conflicts, and retrieving historical versions of code. The ability to efficiently access and use source code repositories is significant to maintaining streamlined workflows, particularly in collaborative development environments involving geographically distributed teams.

Despite the widespread adoption of source code repositories, challenges remain in optimizing their accessibility and usability. For example, developers often encounter difficulties in managing complex repository structures, resolving merge conflicts, and ensuring consistency across multiple branches. Additionally, in environments with multiple interconnected repositories, navigating the relationships between repositories and dependencies can become cumbersome and error-prone. Furthermore, the integration of source code repositories with development tools, such as CI/CD pipelines, testing frameworks, and project management systems, often requires custom configurations and extensive effort.

There is a growing need for improved systems and methods that enhance the accessibility, efficiency, and usability of source code repositories. Such improvements could streamline software development workflows, reduce errors, and increase productivity for developers and teams. Accordingly, there remains an opportunity to develop novel approaches for accessing, managing, understanding, and using source code repositories to address these and other challenges in the field.

### SUMMARY

Described herein are embodiments (e.g., a method, a system, non-transitory computer-readable medium storing code or instructions executable by one or more processors) pertaining to techniques for using conversational artificial intelligence to understand and manage source code repositories in software development environments.

In various embodiments, a computer-implemented method is provided for that comprises: receiving an utterance concerning code in a codebase; generating an utterance vector embedding based on the utterance; executing a similarity search on a vector index by comparing the utterance vector embedding to vector embeddings stored in the vector index using a similarity metric and identifying relevant nodes in a graph-based representation of the codebase based on the comparing, wherein each of the vector embeddings stored in the vector index represent parameters or attributes of the code in a continuous vector space, and where the parameters or attributes for each of the vector embeddings are associated with a node in the graph-based representation of the codebase; executing, based on types of constructs associated with the relevant nodes, queries on a graph database to retrieve additional context associated with the relevant nodes, where the graph database stores the graph-based representation of the codebase; generating a prompt comprising the utterance, the relevant nodes, and the additional context associated with the relevant nodes; and generating, by a generative model, a response to the utterance based on the prompt.

In some embodiments, comparing the utterance vector embedding to the vector embeddings comprises: calculating the similarity metric between the utterance vector embedding and each of the vector embeddings, comparing the similarity metric between the utterance vector embedding and each of the vector embeddings to a predetermined similarity threshold, when the similarity metric is equal to or greater than the predetermined similarity, the node associated with the vector embedding is identified as a relevant node, and when the similarity metric is less than the predetermined similarity, the node associated with the vector embedding is identified as a non-relevant node.

In some embodiments, the computer-implemented method further comprises performing an iterative process for each of the relevant nodes, which comprises analyzing each of the relevant nodes; and identifying, based on the analyzing, the types of constructs associated with the relevant nodes.

In some embodiments, the types of constructs associated with the relevant nodes are node label types; the queries executed on the graph database are graph queries; the graph queries are executed for each of the types of constructs associated with the relevant nodes to retrieve the additional context associated with the relevant nodes; and the additional context includes connected nodes, function invocations, dependencies, and related files.

In some embodiments, the computer-implemented method further comprises: compiling the properties or attributes for each of the relevant nodes and connected nodes, the properties or attributes for edges that represent relationships between each of the relevant nodes and the connected nodes in the graph-based representation of the codebase, and the additional context within a context list in association with each of the relevant nodes; and generating a data structure comprising the utterance and the context list, wherein the prompt is generated using: (i) the data structure, and (ii) predefined templates, formatting rules, or a combination thereof.

In some embodiments, the generative model comprises a transformer network including of multiple layers containing a multi-head, self-attention mechanism and a position-wise, feed-forward network, the multi-head, self-attention mechanism is configured to enable parallel processing of input sequences from the prompt, allowing the generative model to simultaneously evaluate the importance of different segments of the input sequences relative to each other, the position-wise, feed-forward network includes two linear transformations with a non-linear activation function in between, and each element of the input sequences, enriched with context including the importance of different segments of the input sequences relative to each other by the multi-head, self-attention mechanism, is processed independently through the same feed-forward network.

In some embodiments, the computer-implemented method further comprises displaying the response on a user interface, wherein the utterance is received via the user interface, the user interface is part of an application associated with an AI-powered chatbot system.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein.

Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 shows a block diagram of an AI-Powered Chatbot System in accordance with various embodiments.

FIG. 2 shows a block diagram of AI Platform in accordance with various embodiments.

FIG. 3 depicts a flowchart illustrating a code ingestion workflow in accordance with various embodiments.

FIG. 4 depicts a flowchart illustrating a data preparation process in accordance with various embodiments.

FIG. 5 illustrates construction of a graph comprising nodes and edges in accordance with various embodiments.

FIG. 6 depicts a flowchart illustrating a production (inference phase) workflow in accordance with various embodiments.

FIG. 7 depicts a flowchart illustrating a process for using conversational artificial intelligence to understand and manage source code repositories in accordance with various embodiments.

FIG. 8 is a block diagram illustrating one pattern for implementing a cloud infrastructure as a service system, in accordance with various embodiments.

FIG. 9 is a block diagram illustrating another pattern for implementing a cloud infrastructure as a service system, in accordance with various embodiments.

FIG. 10 is a block diagram illustrating another pattern for implementing a cloud infrastructure as a service system, in accordance with various embodiments.

FIG. 11 is a block diagram illustrating another pattern for implementing a cloud infrastructure as a service system, in accordance with various embodiments.

FIG. 12 is a block diagram illustrating an example computer system, in accordance with various embodiments.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### Introduction

### Challenges Solved

Navigating complex source code is a challenging task, particularly for newcomers to software development. Intricate and inconsistent code structures and lack of clarity in programming can lead to inefficiencies, bugs, and increased development costs. For example, inconsistent code structures across various frameworks and languages can create challenges for developers trying to find specific features. For instance, the way routes and controllers are organized in an Express.js project is quite different from how they are structured in a Django application, even though both frameworks are used to build web applications. These differences require developers to understand each framework's specific conventions, making it more challenging to switch between technologies.

When developers fail to adhere to best practices, such as maintaining consistent formatting, providing meaningful comments, and implementing modular designs, the code becomes harder to understand and modify. These challenges are compounded when legacy systems are involved, as outdated technologies and dependencies can make it difficult to upgrade or integrate new features. Moreover, complex programming systems often create barriers for new developers joining projects, as they require additional time to learn and navigate the intricacies of the codebase

Currently, developers rely on proper static documentation, seniors in the team who have a knowledge base of the code, clear communication among team members, and the use of collaborative tools to ensure all stakeholders have a shared understanding of the system. By fostering a culture of knowledge sharing and continuous improvement, teams try to reduce technical debt, improve code quality, and create systems that are easier to maintain and scale. However, these traditional approaches are often time-consuming and lack the agility required to keep pace with modern software development practices (see, e.g., Hosk, The problems with complex code and complex CRM Customizations, 2015).

### Overview of Embodiments and Solution for Challenges

To address the aforementioned challenges and others faced by conventional source code repository systems, disclosed herein is a source code repository system comprising an AI-powered chatbot, which is capable of capable of querying and understanding codebases (e.g., Java code bases) using natural language. This source code repository system diverges from traditional approaches by recognizing that codebases are inherently graph-like structures and as such can be conceptualized as graphs, where each node represents a class, variable or function, and edges signify connections such as function calls, variable usages or class inheritance. More specifically, to tackle the complexity of these codebases, the source code repository system utilizes a code base ingestion process to represent the codebase as a graph (e.g., Code Property Graph) with a focus on identifying the role of specific properties or attributes of the code, e.g., methods or classes, analyzing dependencies between different code components based on said properties or attributes, and embedding select information in the graph to capture the intent behind code elements. During production or inference phase the source code repository system uses a hybrid retrieval technique that combines embeddings of the graph-based code representation with generative artificial intelligence models (e.g., Large Language Models (LLMs)) to answer user queries effectively.

In various embodiments, a computer implemented method is provided for that comprises: receiving an utterance concerning code in a codebase; generating an utterance vector embedding based on the utterance; executing a similarity search on a vector index by comparing the utterance vector embedding to vector embeddings stored in the vector index using a similarity metric and identifying relevant nodes in a graph-based representation of the codebase based on the comparing, wherein each of the vector embeddings stored in the vector index represent parameters or attributes of the code in a continuous vector space, and where the parameters or attributes for each of the vector embeddings are associated with a node in the graph-based representation of the codebase; executing, based on types of constructs associated with the relevant nodes, queries on a graph database to retrieve additional context associated with the relevant nodes, where the graph database stores the graph-based representation of the codebase; generating a prompt comprising the utterance, the relevant nodes, and the additional context associated with the relevant nodes; and generating, by a generative model, a response to the utterance based on the prompt.

Advantageously, there is no requirement for exact identifiers in queries. For example, users do not need to provide the exact method name, class name, or file name in their queries. Instead, the source code repository system retrieves relevant code components based on semantic similarity, making it more flexible and user-friendly. Moreover, there is minimal embedding generation. In other words, the source code repository system generates embeddings only for selected properties or attributes of the code. Depending on the programming language, key constructs (properties or attributes of the code) that best represent the purpose of the code are identified and selected for embedding generation (e.g., for Java method and class names may be selected). This significantly reduces both CPU usage and memory consumption during the embedding generation process. Lastly, graph query execution is based on similarity search results. After identifying relevant nodes through similarity search, the system performs graph queries to gather additional context (e.g., dependencies, invocations) targeting only the most relevant parts of the graph. By focusing graph queries on similarity search results, it optimizes both retrieval time and resource usage.

As used herein, the terms “about,” “similarly,” “substantially,” and “approximately” are defined as being largely but not necessarily wholly what is specified (and include wholly what is specified) as understood by one of ordinary skill in the art. In any disclosed embodiment, the term “about,” “similarly,” “substantially,” or “approximately” may be substituted with “within [a percentage] of” what is specified, where the percentage includes 0.1 percent, 1 percent, 5 percent, and 10 percent, etc.

As used herein, when an action is “based on” something, this means the action can be based at least in part on at least a part of the something.

### Source Code Repositories and Associated Challenges

The onboarding of new developers in software development teams is pivotal for ensuring swift acclimatization and productivity. The complexity of project repositories often poses a significant challenge for newcomers, who must navigate files, understand code functionalities, and keep abreast of ongoing changes. Traditional onboarding methodologies, which usually depend on mentorship and static documentation, are not only inconsistent but also struggle to keep pace with the dynamic evolution of software projects, leading to outdated information.

Advancements in artificial intelligence (AI) have significantly changed the landscape of software development, with conventional tools like GitHub Copilot. GitHub Copilot, integrated into Microsoft's VS Code, employs AI to streamline coding tasks, offering autocomplete suggestions and code generation capabilities. However, while AI has made significant progress in code generation, understanding and navigating complex codebases remain challenging tasks. It is easy to figure out what a self-standing script performs if you look at it and write it in a language you are comfortable with. The codebase is what makes the code difficult to understand rather than the code itself. Understanding the functions of individual scripts, modules, and packages can be challenging when there are hundreds of interdependent scripts. This disclosure and the embodiments described herein endeavor to address these challenges and others to improve codebase comprehension and navigation. By exploring new avenues in AI research, this disclosure and the embodiments described herein empowers developers with more effective tools for working with large-scale software projects.

More specifically, described herein is an AI-powered chatbot designed to aid newcomers by providing instant, comprehensive responses to queries concerning project repositories. This chatbot utilizes generative artificial intelligence models (e.g., LLMs) to interpret natural language questions, offering real-time assistance with relevant code snippets, documentation references, and insights into possible improvements. The integration of knowledge graphs and vector indexes enables a seamless connection between the chatbot and internal data sources, enhancing prompt engineering and ensuring the efficient retrieval of information. Although the techniques described herein focus on understanding source code repositories, it should be understood that the scope of the chatbot can be expanded to source code repository services such as version control, with the ability to analyze historical changes and their impacts. This disclosure delineates the development and anticipated advantages of employing an AI-enabled chatbot in modernizing onboarding practices within the software industry, thereby enhancing the learning curve and integration of new developers.

### AI-Powered Chatbot System and AI Platform

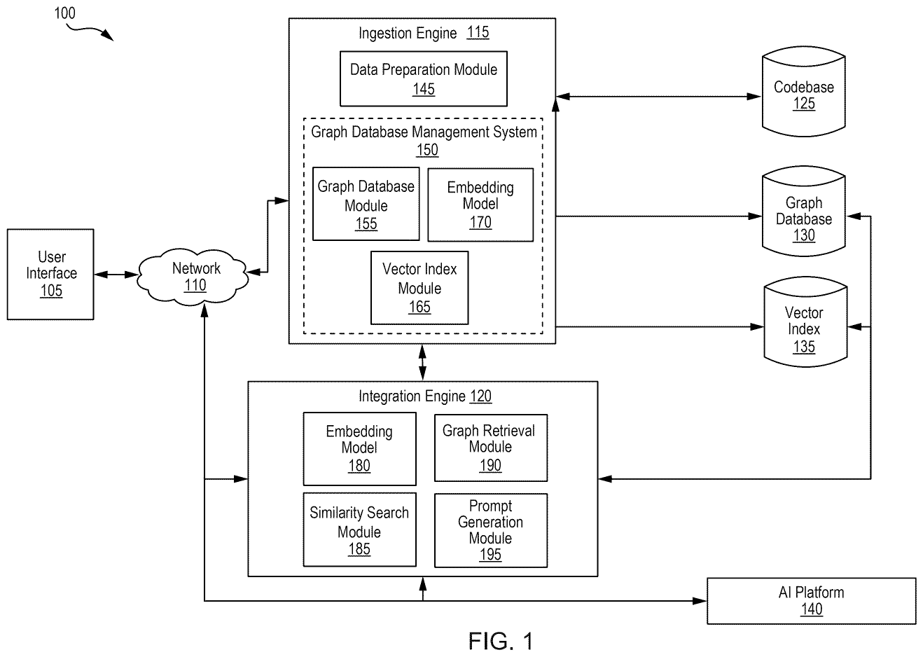

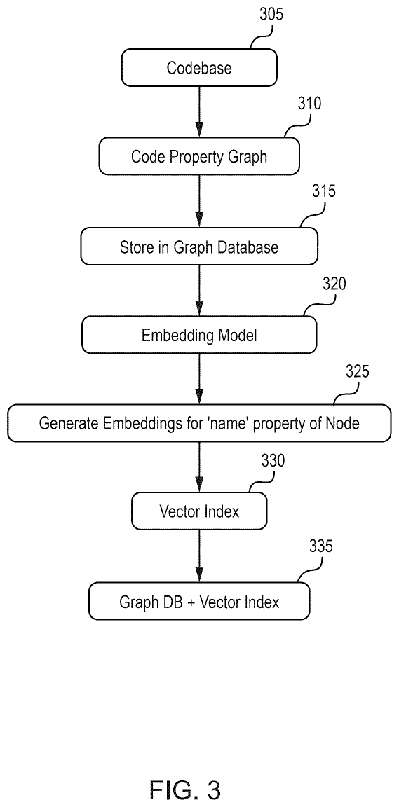

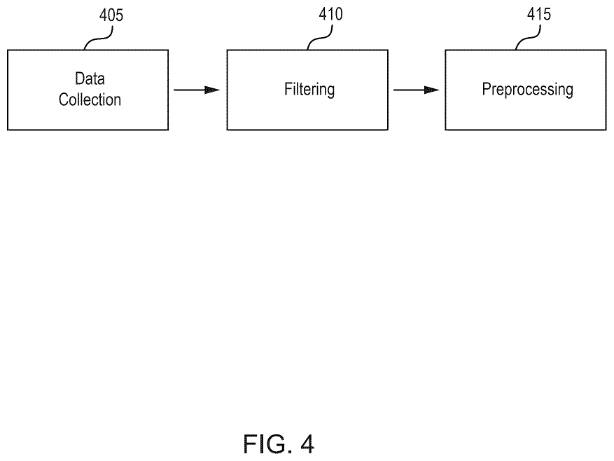

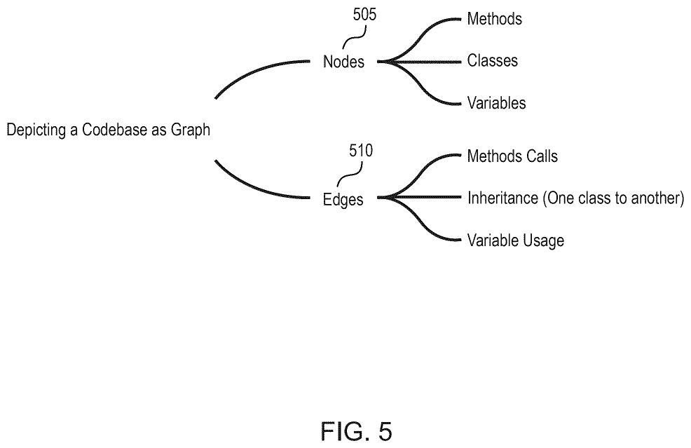

FIG. 1 shows a block diagram illustrating aspects of an AI-Powered Chatbot System 100. The AI-Powered Chatbot System 100 can be used to implement the codebase ingestion as described in FIGS. 3-6 and can be used to implement the integration of generative artificial intelligence models with the graph database management system as described with respect to FIGS. 4-5. As depicted in FIG. 1, the AI-Powered Chatbot System 100 can include a user interface 105, a network 110, an ingestion engine 115, an integration engine 120, a codebase 125, a graph database 130, a vector index 135, and an AI platform 140. Each component should be understood to be configured to execute one or more processes and/or programs implemented with software, hardware, and/or firmware within a system (e.g., as described in further detail with respect to FIGS. 3-13).

The user interface 105 is the point of interaction between the user and a codebase assistant application (e.g., software), enabling users to navigate, control, and utilize the application's features and functions effectively. It includes the design, layout, and elements such as buttons, menus, icons, text fields, and visual or interactive components that facilitate communication between the user and the AI-Powered Chatbot System 100. The user interface 105 can be a graphical (GUI), text-based interface, voice-activated interface, or any combination thereof. The user interface 105 prioritizes usability, accessibility, and aesthetic appeal, ensuring that users can intuitively use the codebase assistant application with minimal effort or confusion.

The network 110 is a system of interconnected devices and technologies configured to transmit data, voice, video, and other types of information between users or systems. It facilitates the exchange of information over physical or wireless mediums, enabling seamless communication across various distances and scales. Examples of networks 110 include the Internet, which is a global network connecting millions of devices worldwide; Local Area Networks (LANs), which operate within a limited geographical area like an office or home; Wide Area Networks (WANs), which span broader regions such as cities or countries; and cellular networks, which allow mobile devices to communicate over large distances using wireless signals. Other examples include satellite networks and private networks such as intranets.

The ingestion engine 115 is a system of interconnected devices, software modules, and technologies configured to transform at least a portion of a codebase 125 into a graph and vector embeddings. The ingestion engine 115 comprises a data preparation module 145 for performing data collection, filtering, and preprocessing of data from the codebase 125 and a graph database management system 150 (e.g., Neo-4j) for storing at least a portion of the codebase 125 as a graph of interconnected nodes (e.g., functions, records), enabling structured queries and exploration of relationships and dependencies within the code. The graph database management system 150 comprises a graph database module 155 configured to represent the codebase as a graph (e.g., a Code Property Graph (CPG) using the Fraunhofer AISEC library). The graph is ingested into graph database 130 (e.g., Neo-4j graph database), where each code component (e.g., MethodDeclaration, RecordDeclaration) is stored as a node, and edges capture relationships and dependencies. This preprocessing step establishes a structured representation of the codebase 125. The graph database management system 150 further comprises a vector index module 165 configured to capture the intent behind each code component. In order to capture the intent, the vector index module 165 creates vector embeddings based on the properties or attributes (e.g., names of method and class declaration) of nodes in the graph, leveraging an embedding model 170 such as Cohere's embedding model (embed-english-v3.0). Vector index module 165 then stores the vector embeddings in a searchable vector index 135 (e.g., Neo4j Vector). This allows for the AI-Powered Chatbot System 100 to match query to code components semantically by similarity in intent.

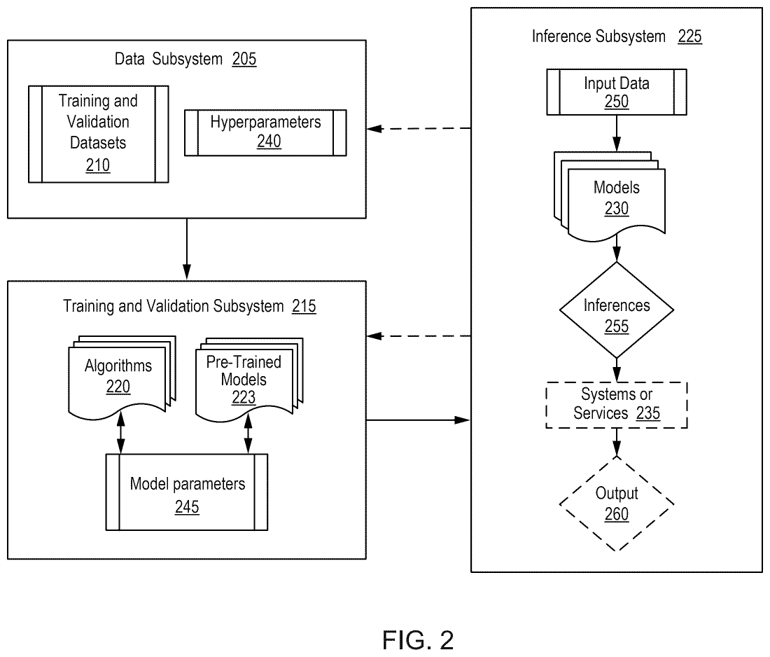

The integration engine 120 is a system of interconnected devices, software modules, and technologies configured to answer questions about the codebase 125 using the graph and vector embeddings, providing clear, contextually relevant responses about how various parts of the code connect and are utilized. The integration engine 120 comprises an embedding model 180 (same or different from embedding model 170) configured to generate an embedding that represents input data received via the user interface 105. The embedding is a means of representing objects like text, images and audio as points in a continuous vector space where the locations of those points in space are semantically meaningful to machinelearning (ML) algorithms. The integration engine 120 further comprises a similarity search module 185 configured to perform a similarity search based on embeddings (i.e., the vector embeddings stored in vector index 175 and the embedding that represents input data received via the user interface 105) to identify nodes relevant to a user's utterance (e.g., query). For each node retrieved by the similarity search module 185, graph (e.g., cypher) queries are run on graph database 130 and/or vector index 135, using graph-retrieval module 190, to gather additional context, such as function invocations, dependencies, and related files. This graph-based retrieval enables the AI-Powered Chatbot System 100 to obtain interconnected data (additional context) important for responding to utterances (e.g., answering queries). Overlying the similarity search module 185 and graph-retrieval module 190 is a software framework such as LangChain that provides utilities for integrating graph database management system 150 with generative models developed and deployed using AI platform 140 (described in detail below with respect to FIG. 2), enabling both graph-based and embedding-based retrieval workflows.

The integration engine 120 further comprises a prompt generation module 195 configured to compile the user's utterance and the retrieved additional context into a structured prompt. This prompt is sent via integration engine 120 to one or more generative models (e.g., LLMs) of AI platform 140, which generates a detailed, context-aware response based on the user's utterance and the contextual code component relationships. This ensures that developers receive relevant response (e.g., answer to their query) with code dependencies and connections derived from the additional context, easing navigation of complex codebases such as codebase 125.

FIG. 2 shows a block diagram of an AI Platform 200 comprising several subsystems that work together to train, validate, and implement one or more machine learning models in accordance with various embodiments. The AI Platform 200 may be executed as part of the AI-Powered Chatbot System 100 described in FIG. 1 to train or fine-tune one or more machine learning models (e.g., one or more generative models) with training data—and deploy and use said one or more machine learning models as described herein.

The AI Platform 200 comprises a data subsystem 205 for collecting, generating, preprocessing, and labeling of training and validation datasets 210, training and validation subsystem 215 that facilitates the training and validation of one or more machine learning algorithms 220 or one or more pre-trained machine learning models 223, and inference subsystem 225 for deploying and implementing one or more trained machine learning models 230 independently or in combination with one or more other systems or services 235 for downstream processes.

As used herein, machine learning algorithms (also described herein as simply algorithm or algorithms) are procedures that are run on datasets (e.g., training and validation datasets) and perform pattern recognition on datasets, learn from the datasets, and/or are fit on the datasets. Examples of machine learning algorithms include linear and logistic regression, decision trees, artificial neural networks, k-means, transformer architectures with attention mechanisms, and k-nearest neighbor. In contrast, machine learning models (also described herein as simply model or models) are the output of the machine learning algorithms and are comprised of model data and a prediction algorithm. In other words, the machine learning model is the program that is saved after running a machine learning algorithm on training data and represents the rules, numbers, and any other algorithm-specific data structures required to make inferences. For example, a linear regression algorithm may result in a model comprised of a vector of coefficients with specific values, and a transformer architecture with attention mechanisms may result in a LLM that utilizes self-attention mechanisms, allowing the model to weigh the importance of different words in a sentence when making predictions.

In the specific context of this disclosure, the machine learning model(s) may be one or more generative models. A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model (LLM). Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times and inference latency times.

A mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

Transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

Following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

Integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

### Data Subsystem

Data subsystem 205 is used to collect, generate, preprocess, and label data to be used to train and validate one or more machine learning algorithms 220 or one or more pre-trained machine learning models 223. The data collection can include exploring various data sources such as public datasets, private data collections, or real-time data streams, depending on a project's needs. In some instances, a data source is a public or online repository of information or examples pertinent to a general or target domain space (e.g., Java codebase or code repository). Many domains have publicly available datasets provided by governments, universities, or organizations. For example, many government and private entities offer datasets on healthcare, environmental data, and more through various portals. For proprietary needs, data might be available through partnerships or purchases from private companies that specialize in data aggregation. In other instances, a data source is a private repository of information or examples pertinent to a general or target domain space. For example, a data source can be the storage device that stores code accessed by the AI-Powered Chatbot System 100 described in FIG. 1. Once a data source is identified, data subsystem 205 can be used to collect data through appropriate methods such as downloading from online repositories, web scraping, using APIs for real-time data, creating datasets through surveys and requests for access, or by running programs or scripts. The acquired raw data may be further preprocessed to generate the training and validation datasets 210.

In some instances, raw data (e.g., text scripts and associated audio) may be generated as opposed to being collected or acquired. Data generating may comprise data synthesis and/or data augmentation. Different data synthesis and/or data augmentation techniques may be implemented by the data subsystem 205 to generate data to be used for the training and validation subsystem 215. Data synthesizing involves creating entirely new data points from scratch. Data synthesis may be used when real data is insufficient, too sensitive to use, or when the cost and logistical barriers to obtaining more real data are too high. The synthesized data should be realistic enough to effectively train a machine learning model, but distinct enough to comply with regulations (e.g., copyright and data privacy), if necessary. Data augmentation, on the other hand, refers to techniques used to artificially expand the size of a dataset by creating modified versions of existing data examples. The primary goal of data augmentation is to increase variation in the data in order to make the model more robust to variations it might encounter in the real world, thereby improving its ability to generalize from the training data to unseen data. This is especially common in image and speech recognition tasks but is applicable to other data types as well. For images, data augmentation may include rotations, flipping, scaling, or altering the lighting conditions. For text, data augmentation may include synonyms replacement, back translation, or sentence shuffling. For audio, data augmentation may include changes made to pitch, speed, or background noise.

Preprocessing may be implemented by the data subsystem 205, serving as a bridge between raw data acquisition and effective model training. The primary objective of preprocessing is to transform the raw data into a format that is more suitable and efficient for analysis, ensuring that the data fed into machine learning algorithms or pretrained models is clean, consistent, and relevant. This step can be useful because raw data often comes with a variety of issues such as missing values, noise, irrelevant information, and inconsistencies that can significantly hinder the performance of a model. By standardizing and cleaning the data beforehand, preprocessing helps in enhancing the accuracy and efficiency of the subsequent analysis, making the data more representative of the underlying problem the model aims to solve.

Other raw data preprocessing techniques that may be utilized include data cleaning, normalization, feature extraction, dimensionality reduction, and the like. Data cleaning may involve removing duplicates, filling in missing values, or filtering out outliers to improve data quality. Normalization involves scaling numeric values to a common scale without distorting differences in the ranges of values, which helps prevent biases in the model due to the inherent scale of features. Feature extraction involves transforming the input data into a set of useable features, possibly reducing the dimensionality of the data in the process. For instance, in audio analysis, feature reduction techniques such as Principal Component Analysis (PCA), Linear Discriminant Analysis (LDA), t-Distributed Stochastic Neighbor Embedding (t-SNE), Non-Negative Matrix Factorization (NMF), and feature selection can be used for simplifying the representation of audio signals while retaining the most relevant information for tasks like classification, recognition, or synthesis. These techniques not only help in reducing the computational load on the model but also in mitigating issues like overfitting by simplifying the data without losing critical information.

In the instance that AI Platform 200 is used for supervised or semi-supervised learning of machine learning models, labeling techniques can be implemented as part of the data collection. The quality and accuracy of data labeling directly influence the model's performance, as labels serve as the definitive guide that the model uses to learn the relationships between the input features and the desired output. Particularly in complex domains such as image analysis, natural language processing, or medical diagnosis, precise and consistent labeling is important because it provides the ground truth or target outcomes against which the model's predictions are compared and adjusted during training. Effective labeling ensures that the model is trained on correct and clear examples, thus enhancing its ability to generalize from the training data to real-world scenarios. In some instances, the annotation labels and ground truth values (labels) are appended or annotated within the raw data. For example, when the raw data includes text scripts, the labels may include the one or more spans and corresponding named entities.

Labeling techniques can vary significantly depending on the type of data and the specific requirements of the project. Manual labeling, where human annotators label the data, is one method that can be used. This approach may be useful when a detailed understanding and judgment are required, such as in labeling medical text or categorizing text data where context and subtlety are important. However, manual labeling can be time-consuming and prone to inconsistency, especially with a large number of annotators. To mitigate this, semi-automated labeling tools may be used as part of data subsystem 205 to pre-label data using algorithms, which human annotators may then review and correct as needed. Another approach is active learning, a technique where the model being developed is used to label new data iteratively. The model suggests labels for new data points, and human annotators may review and adjust certain predictions such as the most uncertain predictions. This technique optimizes the labeling effort by focusing human resources on a subset of the data, e.g., the most ambiguous cases, improving efficiency and label quality through continuous refinement.

Once collected, generated, preprocessed, and/or labeled, the data may then be split into the training and validation datasets 210. The training and validation datasets 210 may comprise the raw data and/or the preprocessed data. The training and validation datasets 210 are typically split into at least three subsets of data: training, validation, and testing. The training set is used to fit the model, where the machine learning model learns to make inferences based on the training data. The validation set, on the other hand, is utilized to tune hyperparameters and prevent overfitting by providing a sandbox for model selection. Finally, the test set serves as a new and unseen dataset for the model, used to simulate real-world application and evaluate the final model's performance. The process of splitting ensures that the model can perform well not just on the data it was trained on, but also on new, unseen data, thereby validating and testing its ability to generalize.

Various techniques can be employed to split the data effectively, with each method aiming to maintain a good representation of the overall dataset in each subset. A simple random split (e.g., a 70/20/10%, 80/10/10%, or 60/25/15%) is the most straightforward approach, where examples from the data are randomly assigned to each of the three sets. In some instances, the splitting is performed such that 70% of the training and validation datasets 210 are for training, 10% are for validation, and 20% are for testing. However, more sophisticated methods may be necessary to preserve the underlying distribution of data. For instance, stratified sampling may be used to ensure that each split reflects the overall distribution of a specific variable, particularly useful in cases where certain categories or outcomes are underrepresented. Another technique, k-fold cross-validation, involves rotating the validation set across different subsets of the data, maximizing the use of available data for training while still holding out portions for validation. These methods help in achieving more robust and reliable model evaluation and are useful in the development of predictive models that perform consistently across varied datasets.

Data subsystem 205 is also used for collecting, generating, setting, or implementing model hyperparameters 240 for the training and validation subsystem 215. The hyperparameters control the overall behavior of the models. Unlike model parameters 245 that are learned automatically during training, hyperparameters 240 are set before training begins and have a significant impact on the performance of the model. For example, in a neural network such as that of an LLM, hyperparameters include the learning rate, number of layers, number of neurons/nodes per layer, activation functions, convolution kernel width, the number of kernels for a model, among others. These settings can determine how quickly a model learns, its capacity to generalize from training data to unseen data, and its overall complexity. Correctly setting hyperparameters is important because inappropriate values can lead to models that underfit or overfit the data. Underfitting occurs when a model is too simple to learn the underlying pattern of the data, and overfitting happens when a model is too complex, learning the noise in the training data as if it were signal.

### Training, Validation, and Testing

The training and validation subsystem 215 is comprised of a combination of specialized hardware and software to efficiently handle the computational demands required for training, validating, and testing a machine learning model. On the hardware side, high-performance GPUs (Graphics Processing Units) may be used for their ability to perform parallel processing, drastically speeding up the training of complex models, especially deep learning networks. CPUs (Central Processing Units), while generally slower for this task, may also be used for less complex model training or when parallel processing is less critical. TPUs (Tensor Processing Units), designed specifically for tensor calculations, provide another level of optimization for machine learning tasks. On the software side, a variety of frameworks and libraries are utilized, including TensorFlow, PyTorch, Keras, and scikit-learn. These tools offer comprehensive libraries and functions that facilitate the design, training, validation, and testing of a wide range of machine learning models across different computing platforms, whether local machines, cloud-based systems, or hybrid setups, enabling developers to focus more on model architecture and less on underlying computational details.

Training is the initial phase of developing machine learning models 230 where the model learns to make predictions or decisions based on data training data provided from the training and validation datasets 210. During this phase, the model iteratively adjusts its internal model parameters 245 to achieve a preset optimization condition. In a supervised machine learning training process, the preset optimization condition can be achieved by minimizing the difference between the model output (e.g., predictions, classifications, or decisions) and the ground truth labels in the training data. In some instances, the preset optimization condition can be achieved when the preset fixed number of iterations or epochs (full passes through the training dataset) is reached. In some instances, the preset optimization condition is achieved when the performance on the validation dataset stops improving or starts to degrade. In some instances, the preset optimization condition is achieved when a convergence criterion is met, such as when the change in the model parameters falls below a certain threshold between iterations. This process, known as fitting, is fundamental because it directly influences the accuracy and effectiveness of the model.

In an exemplary training phase performed by the training and validation subsystem 215, the training subset of data is input into the machine learning algorithms 220 or pre-trained models 223 to find a set of model parameters 245 (e.g., weights, coefficients, trees, feature importance, and/or biases) that minimizes or maximizes an objective function (e.g., a loss function, a cost function, a contrastive loss function, a cross-entropy loss function, an Out-of-Bag (OOB) score, etc.). To train the machine learning algorithms 220 or pre-trained models 223 to achieve accurate predictions, “errors” (e.g., a difference between a predicted label and the ground truth label) need to be minimized. In order to minimize the errors, the model parameters can be configured to be incrementally updated by minimizing the objective function over the training phase (“optimization”). Various different techniques may be used to perform the optimization. For example, to train machine learning algorithms or pre-trained models such as a neural network, optimization can be done using back propagation. The current error is typically propagated backwards to a previous layer, where it is used to modify the weights and bias in such a way that the error is minimized. The weights are modified using the optimization function. Other techniques such as random feedback, Direct Feedback Alignment (DFA), Indirect Feedback Alignment (IFA), Hebbian learning, and the like can also be used to update the model parameters 245 in a manner as to minimize or maximize an objective function. This cycle is repeated until a desired state (e.g., a predetermined minimum value of the objective function) is reached.

The training phase is driven by three primary components: the model architecture (which defines the structure of the algorithm(s) 220 or pretrained model(s) 223), the training data (which provides the examples from which to learn), and the learning algorithm (which dictates how the model adjusts its model parameters). The goal is for the model to capture the underlying patterns of the data without memorizing specific examples, thus enabling it to perform well on new, unseen data.

The model architecture is the specific arrangement and structure of the various components and/or layers that make up a model. In the context of a neural network, the model architecture may include the configuration of layers in the neural network, such as the number of layers, the type of layers (e.g., convolutional, recurrent, fully connected), the number of neurons in each layer, and the connections between these layers. In the context of a LLM comprised of a transformer architecture, which utilizes self-attention mechanisms to process and generate human-like text. The transformer model comprises an encoder-decoder structure, where the encoder processes the input text, and the decoder generates the output. The self-attention mechanism allows the model to weigh the importance of different words in a sentence, capturing long-range dependencies and contextual relationships. This architecture enables the model to handle large-scale data and understand complex language patterns. During training, the optimization algorithm such as Adam is used to minimize the loss function through backpropagation, and regularization techniques like dropout are employed to prevent overfitting, resulting in a robust and efficient language model capable of performing various natural language processing tasks such as predicting the ADR relations.

The model architecture also encompasses the choice and arrangement of features and algorithms used in various models, such as neural networks and transformers. The architecture determines how input data is processed and transformed through various computational steps to produce the output. The model architecture directly influences the model's ability to learn from the data effectively and efficiently, and it impacts how well the model performs tasks such as classification, regression, or prediction, adapting to the specific complexities and nuances of the data it is designed to handle.

The learning algorithm is the overall method or procedure used to adjust the model parameters 245 to fit the data. It dictates how the model learns from the data provided during training. This includes the steps or rules that the algorithm follows to process input data and make adjustments to the model's internal parameters (e.g., weights in neural networks) based on the output of the objective function. Examples of learning algorithms include gradient descent, backpropagation for neural networks, and splitting criteria in decision trees.

Various techniques may be employed by training and validation subsystem 215 to train machine learning models 230 using the learning algorithm, depending on the type of model and the specific task. For supervised learning models, where the training data includes both inputs and expected outputs (e.g., ground truth labels), gradient descent is a possible method. This technique iteratively adjusts the model parameters 245 to minimize or maximize an objective function (e.g., a loss function, a cost function, a contrastive loss function, etc.). The objective function is a method to measure how well the model's predictions match the actual labels or outcomes in the training data. It quantifies the error between predicted values and true values and presents this error as a single real number. The goal of training is to minimize this error, indicating that the model's predictions are, on average, close to the true data. Common examples of loss functions include mean squared error for regression tasks and cross-entropy loss for classification tasks.

The adjustment of the model parameters 245 is performed by the optimization function or algorithm, which refers to the specific method used to minimize (or maximize) the objective function. The optimization function is the engine behind the learning algorithm, guiding how the model parameters 245 are adjusted during training. It determines the strategy to use when searching for the best weights that minimize (or maximize) the objective function. Gradient descent is a primary example of an optimization algorithm, including its variants like stochastic gradient descent (SGD), mini-batch gradient descent, and advanced versions like Adam or RMSprop, which provide different ways to adjust learning rates or take advantage of the momentum of changes. For example, in training a neural network, backpropagation may be used with gradient descent to update the weights of the network based on the error rate obtained in the previous epoch (cycle through the full training dataset). Another technique in supervised learning is the use of decision trees, where a tree-like model of decisions is built by splitting the training dataset into subsets based on an attribute value test. This process is repeated on each derived subset in a recursive manner called recursive partitioning.

In unsupervised learning, where training data does not include labels, different techniques are used. Clustering is one method where data is grouped into clusters that maximize the similarities of data within the same cluster and maximize the differences with data in other clusters. The K-Means algorithm, for example, assigns each data point to the nearest cluster by minimizing the sum of distances between data points and their respective cluster centroids. Another technique, Principal Component Analysis (PCA), involves reducing the dimensionality of data by transforming it into a new set of variables, the principal components, which are uncorrelated and ordered so that the first few retain most of the variation present in all of the original variables. These techniques help uncover hidden structures or patterns in the data, which can be essential for feature reduction, anomaly detection, or preparing data for further supervised learning tasks.

Validating is another phase of developing machine learning models 230 where the model is checked for deficiencies in performance and the hyperparameters 240 are optimized based on validation data provided from the training and validation datasets 210. The validation data helps to evaluate the model's performance, such as accuracy, precision, recall, or F1-score, to gauge how well the model is likely to perform in real-world scenarios. Hyperparameter optimization, on the other hand, involves adjusting the settings that govern the model's learning process (e.g., learning rate, number of layers, size of the layers in neural networks) to find the combination that yields the best performance on the validation data. One optimization technique is grid search, where a set of predefined hyperparameter values are systematically evaluated. The model is trained with each combination of these values, and the combination that produces the best performance on the validation set is chosen. Although thorough, grid search can be computationally expensive and impractical when the hyperparameter space is large. A more efficient alternative optimization technique is random search, which samples hyperparameter combinations from a defined distribution randomly. This approach can in some instances find a good combination of hyperparameter values faster than grid search. Advanced methods like Bayesian optimization, genetic algorithms, and gradient-based optimization may also be used to find optimal hyperparameters more effectively. These techniques model the hyperparameter space and use statistical methods to intelligently explore the space, seeking hyperparameters that yield improvements in model performance.

An exemplary validation process includes iterative operations of inputting the validation subset of data into the trained algorithm(s) using a validation technique such as K-Fold Cross-Validation, Leave-one-out Cross-Validation, Leave-one-group-out Cross-Validation, Nested Cross-Validation, or the like, to fine-tune the hyperparameters and ultimately find the optimal set of hyperparameters. In some instances, a 5-fold cross-validation technique may be used to avoid overfitting the trained algorithm and/or to limit the number of selected features per split to the square-root of the total number of input features. In some instances, training dataset is split into 5 equal-size cohorts (or about equal-size), and every four of the cohorts are used to train an algorithm to generate five models (e.g., cohorts #1, 2, 3, and 4 are used to train and generate model 1, cohorts #1, 2, 3, and 5 are used to train and generate model 2, cohorts #1, 2, 4, and 5 are used to train and generate model 3, cohorts #1, 3, 4, and 5 are used to train and generate model 4, and cohorts #2, 3, 4 and 5 are used to train and generate model 5). Each model is evaluated (or validated) using the unused cohort in the training (e.g., for model 5, cohort #1 is used for validation). The overall performance of the training can be evaluated by an average performance of the five models. K-fold cross-validation provides a more robust estimate of a model's performance compared to a single training/validation split because it utilizes the entire dataset for both training and evaluation and reduces the variance in the performance estimate.

Once a machine learning model has been trained and validated, it undergoes a final evaluation using test data provided from the training and validation datasets 210, which is a separate subset of the data that has not been used during the training or validation phases. This step is crucial as it provides an unbiased assessment of the model's performance in simulating real-world operation. The test dataset serves as new, unseen data for the model, mimicking how the model would perform when deployed in actual use. During testing, the model's predictions are compared against the true values in the test dataset using various performance metrics such as accuracy, precision, recall, and mean squared error, depending on the nature of the problem (classification or regression). This process helps to verify the generalizability of the model—its ability to perform well across different data samples and environments—highlighting potential issues like overfitting or underfitting and ensuring that the model is robust and reliable for practical applications. The machine learning models 230 are fully validated and tested once the output predictions have been deemed acceptable by user defined acceptance parameters. Acceptance parameters may be determined using correlation techniques such as Bland-Altman method and the Spearman's rank correlation coefficients and calculating performance metrics such as the error, accuracy, precision, recall, receiver operating characteristic curve (ROC), etc.

### Inference Phase for Machine Learning Models

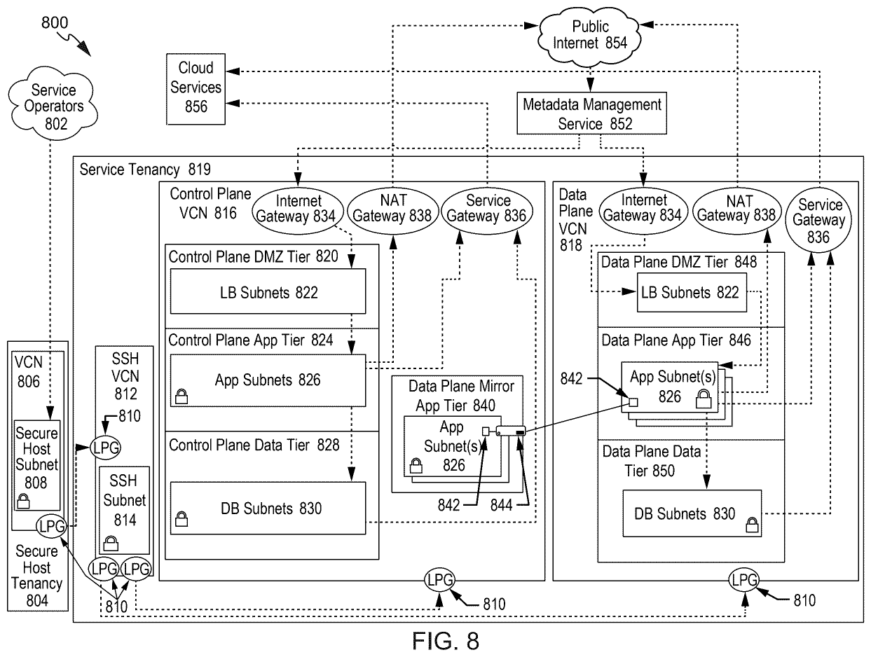

The inference subsystem 225 is comprised of various components for deploying the machine learning models 230 in a production environment (e.g., use as cloud service as described with respect to FIGS. 8-12). Deploying the machine learning models 230 includes moving the models from a development environment (e.g., the training and validation subsystem 215, where it has been trained, validated, and tested), into a production environment where it can make inferences on real-world data (e.g., input data 250). This step typically starts with the model being saved after training, including its parameters and configuration such as final architecture and hyperparameters. It is then converted, if necessary, into a format that is suitable for deployment, depending on the deployment environment. For instance, a model trained in a scientific computing environment such as Python might be converted into a Java-friendly format for integration into a larger enterprise application.

Deployment can be conducted on various platforms, including on-premises servers or cloud environments like Oracle's Cloud Infrastructure (OCI), as described in greater detail with respect to FIGS. 8-12. In some instances, a portion of or the AI-Powered Chatbot System 100 described with respect to FIG. 1 can be bundled into an application using a software framework such as Gradio or LangChain, which is executable on one or more of the various platforms. A Gradio application is an open-source Python package that allows a use to quickly build a demo or web application for their machine learning model, API, or any arbitrary Python function (e.g., a could service application). LangChain provides utilities for integrating generative models into applications. The application can be built to enable users to play around with the training data generator in a playground mode, as well as generate training dataset in bulk, train models using the training dataset, and use the models in a production environment.

Once deployed, the model is ready to receive input data 250 and return outputs (e.g., inferences 255). In some instances, the model resides as a component of a larger system or service (e.g., including additional downstream applications 235). In some instances, the models 230 and/or the inferences 255 can be used by the downstream applications 235 to provide further information. For example, the inferences 255 can be used to for converting text to audio, detecting audio, converting audio to text, and the like. The downstream applications can be configured to generate an output 260. In some instances, the output 260 comprises a report including inferences 255 and information generated by the downstream applications 235.

To manage and maintain its performance, a deployed model may be continuously monitored to ensure it performs as expected over time. This involves tracking the model's prediction accuracy, response times, and other operational metrics. Additionally, the model may require retraining or updates based on new data or changing conditions in the environment it is applied in. This can be useful because machine learning models can drift over time due to changes in the underlying data they are making predictions on—a phenomenon known as model drift. Therefore, maintaining a machine learning model in a production environment often involves setting up mechanisms for performance monitoring, regular evaluations against new test data, and potentially periodic updates and retraining of the model to ensure it remains effective and accurate in making predictions.

### Codebase Ingestion

The present disclosure describes an AI-powered chatbot system (as described in detail with respect to FIG. 1) designed to enable querying and comprehension of codebases (e.g., Java codebases) using natural language inputs. The system achieves this functionality through an end-to-end approach that integrates generative artificial intelligence models, such as LLMs, with graph-based representations of code. The following sections outline the various stages involved in constructing and using the AI-powered chatbot system. While the techniques are primarily described in the context of a Java codebase, it should be understood that these techniques are not limited to Java and can be applied to other types of codebases without departing from the scope and spirit of the present disclosure.

Constructing the AI-powered chatbot system involves code base ingestion. As show in FIG. 3, the codebase ingestion process 300 comprises an initial data preparation step 305 that includes accessing a codebase and preparing data from the codebase. Preparing data from the codebase involves collecting, filtering, and pre-processing data from the codebase. Subsequently, the creation of a codebase graph is outlined in step 310 and stored in a database at step 315, where nodes represent code elements and edges depict their relationships. These preprocessing steps establish a structured representation of the codebase. To capture the intent behind each code component and provide the model with an understanding of code syntax and semantics, an algorithmic framework for representational learning on graphs (e.g., CPG) is employed at step 320 to generate vector embeddings based on properties or attributes of nodes (e.g., the names of method and class declaration nodes). This allows for queries to be matched to code elements semantically by similarity in intent. The vector embeddings are stored in a vector index at step 325. Consequently, the codebase ingestion process 300 at step 330 results in both a codebase graph stored in a database and associated vector embeddings stored in a vector index. The database and vector index may be managed by a same graph database management system such as Neo-4j. Each step of process 300 is examined in further detail below.

### Data Preparation

Data preparation is important for ensuring the quality and relevance of data used for training and analysis. As shown in FIG. 4, the data preparation process includes three main steps: data collection 405, filtering 410, and preprocessing 415.

Data Collection 405: This step involves gathering files in the codebase. While a comprehensive dataset offers diversity, a smaller, focused dataset can be more efficient for domain-specific tasks, reducing noise and irrelevant data.

Filtering 410: This step removes files that won't contribute to training, enhancing model performance. Key actions include:
Autogenerated Files: Exclude files created by build tools or IDEs, like .class files in compiled Java projects, to focus on source code.
Configuration Files: Filter out files with configuration settings, such as .properties and .xml files, as they don't relate to code functionality.
Deduplication: Eliminate duplicate files to avoid redundancy and improve model performance by providing diverse examples.

Preprocessing 415: This step ensures consistent code formatting and involves cleaning the code:
Consistent Code Formatting: Use tools to standardize indentation and remove unnecessary whitespace, maintaining a clean and uniform codebase.

### Building the Code Base Graph

Representing the codebase as a graph is the next step and is important due to the non-linear and complex nature of software systems. If the code within the codebase was simply embedded without initially representing the codebase as a graph, the embedding process would consume significant computational time, energy, and resources (e.g., CPU cycles, memory, and time). There is a need for more efficient methods that can achieve comparable or superior performance without the associated resource burden. The embodiments described herein replace conventional embedding procedures with a graph-based approach that leverages interconnected entities within the code to ultimately generate semantically meaningful representations of the code. More specifically, codebases contain various interconnected entities such as classes, functions, and variables. By capturing these entities and their relationships as a graph, it is possible to achieve an efficient and comprehensive understanding of the code structure. The graph structure enhances the efficiency of embedding processes by organizing data points (nodes) and their relationships (edges) in a way that prioritizes meaningful connections and minimizes the volume of data being embedded thereafter. Instead of performing computationally expensive embedding operations across all code data, graphs enable optimized embedding by focusing only on relevant information captured by nodes and edges (e.g., a look up library of properties or attributes of the code such as class names and method names in the instance of a Java codebase). Additionally, graph algorithms like spectral clustering or manifold learning preserve relationships while reducing dimensionality, resulting in smaller, more efficient embeddings without losing critical contextual information. Graphs also adapt dynamically, making it easy to update embeddings when new data is added, and they support scalable approximate nearest neighbor searches, crucial for large datasets like code repositories. These benefits collectively make embedding processes faster, more scalable, and resource efficient.

As shown in FIG. 5, the process for representing the codebase (all or a portion of the codebase) as a graph includes two main steps: node creation 505 and edge creation 510. In some instances, the codebase is presented as a Code Property Graph (CPG) using a library such as the Fraunhofer AISEC library. CPG is s a computer program representation that captures syntactic structure, control flow, and data dependencies in a property graph. For example, a CPG of code or a program is a graph representation of the code or program obtained by merging several concepts such as an Abstract Syntax Tree (AST), Control Flow Graph (CFG) or Evaluation Order Graph (EOG), Data Flow Graph (DFG) or Control Dependence Graph (CDG), among others, at statement and predicate nodes in a single supergraph. The library takes inputs including: the location of the codebase and the programming language. The library then performs all necessary processing, including the conversion of the code into nodes and edges of the graph based on a schema (represented in a data structure such as a schema file). The schema file includes all node labels and relationships between them that persisted from the in-memory property graph to the graph database such as Neo4j database. The schema file can be generated automatically and can be the same for all programming languages so that graph queries can be written based on the schema agnostic to the programming language. In some instance, a machine learning model such as a generative model (e.g., an LLM) can be fine-tuned on the schema file to train the machine learning model to write out graph queries for the property graph, and thus, address a broader range of questions/queries by users. The graph generated by the library can then be directly stored in the graph database. The resulting graph is a property graph, which is the underlying graph model of graph databases such as Neo-4j, JanusGraph and OrientDB where data is stored in the nodes and edges as key-value pairs

Each node in the graph has properties or attributes. For example, a method declaration node includes: a method's name, return type, parameter types, code, and comments. Edges represent relationships between nodes in the graph and also have properties or attributes, such as invocation edges, which show which methods are invoked by or invoke a current method.

### Node Creation 505:

Identifying Entities: Each class, function, method, record, and variable may be represented as a node. In Java, classes and records serve as blueprints for creating objects, while methods define the actions those objects can perform. A record is a special type of class designed to hold data. It automatically generates methods for accessing the data components.
Node Types: Nodes correspond to different code entities, such as functions, methods, classes, and variables, each with specific attributes derived from the tokens and the node types pertain to distinct constructs with specific purposes involving those code entities. For example, in Java, the node types can include MethodDeclaration and RecordDeclaration. Method declarations and record declarations are distinct constructs with specific purposes. Method declarations focus on defining actions, while record declarations focus on defining data structures.

### Edge Creation 510:

Method call: Created if function A calls function B.
Inheritance: An edge from class C to class D is created if class C inherits from class D.
Variable Usage: An edge from a function or method to a variable is created if it uses that variable.

The graph structure enables querying related nodes, efficient code analysis, and contextual responses. The efficient code analysis facilitates efficient traversal and inspection of code relationships (e.g., understand the relationships better between code elements), aiding in tasks like dependency analysis, impact analysis, and code refactoring. Contextual responses allow for responses to user queries to include contextual information, such as details about other functions a specific function calls or the classes it interacts with.

### Generating Node Embeddings

Node embeddings are generated using an algorithmic framework for representational learning on graphs (e.g., embed-english-v3.0). The node embeddings transform key constructs (e.g., select properties or attributes) represented by the nodes into dense vectors that capture their semantic meaning and relationships within the codebase. These embeddings are useful as inputs for machine learning models to process and generate contextually relevant information. For example, in the instance of a Java codebase, to capture the intent behind code elements, the source code repository system can be configured to convert method names and class names associated with various nodes into embeddings using an embedding model (e.g., embed-english-v3.0). These embeddings are vector representations of the name of the identifiers. They capture the semantic meaning of code components. The system uses these vectors to align user queries with relevant nodes based on intent. For example, a query about a function's purpose can be matched to the correct node, even if the function name is not directly mentioned in the query. Additionally, by focusing on key constructs such as method names and class names rather than converting the entire codebase into embeddings, the AI-powered chatbot system further reduces computational costs and storage requirements. Also, there's no need to repeatedly train a generative model on the codebase, which can be expensive. Instead, relevant information is retrieved from the codebase graph and passed to the generative model.

Embedding models are algorithms trained to encapsulate information into dense representations in a multi-dimensional space. Embeddings can be used for estimating semantic similarity between two texts (e.g., choosing a sentence which is most likely to follow another sentence). The embed-english-v3.0 model can be used to transform text (e.g., method names and class names) into numerical vectors, allowing for efficient semantic search by evaluating not only the topic or code relevance of information such as portions of code in the codebase but also its overall quality, enabling it to rank the most relevant and high-quality information at the top, especially when dealing with noisy datasets such as codebases; this is achieved through a specially designed training process that prioritizes compression-awareness, allowing for handling large volumes of embeddings without significantly increasing underlying infrastructure costs (e.g., the IaaS infrastructure).

### Steps to Generate Node Embeddings:

1. Select parameters or attributes of nodes and edges to be embedded for a particular programming language.
2. The text associated with the parameters or attributes of nodes and edges is then processed through a neural network that generates a vector representation (embedding) where each dimension captures semantic information about the text.
   a. For example, in the instance of a Java codebase, vector embeddings are created based on the names of method and class declaration nodes, leveraging Cohere's embedding model (embed-english-v3.0). This allows for a query to be matched to code elements semantically by similarity in intent.
3. Store the vector representations (embeddings) in a vector index. A vector index is a data structure used in computer science and information retrieval to efficiently store and retrieve high-dimensional vector data, enabling fast similarity searches and nearest neighbor queries.

Consequently, the codebase ingestion process results in both a codebase graph stored in a database and associated vector embeddings stored in a vector index. The database and vector index may be managed by a same graph database management system such as Neo-4j. The graph database management system is a specialized, single-purpose platform for creating and manipulating a graph data model (e.g., Create, Read, Update and Delete (CRUD) operations working on a graph data model including the nodes, relationships, attributes or properties, and embeddings thereof).

### Integrating the Codebase Graph With a Generative AI Model

The next step of constructing and ultimately using the AI-powered chatbot system (e.g., AI-powered chatbot system 100 as described in detail with respect to FIG. 1) involves integrating generative artificial intelligence models with the graph database management system. This can be done using an application development framework or platform that builds applications that use generative artificial intelligence models (e.g., LangChain). The application development framework or platform allows for defining external resources such as the graph database management system to be used in custom workflows. For example, the workflow described below provides for processing user queries in natural language via hybrid data retrieval on the graph database and generation of custom prompts based on the user queries and retrieved data for input into the generative artificial intelligence models. While the workflows are primarily described in the context of a Java codebase and use of LangChain, it should be understood that these techniques are not limited to Java and app development via LangChain and can be applied to other types of codebases and app development platforms without departing from the scope and spirit of the present disclosure.

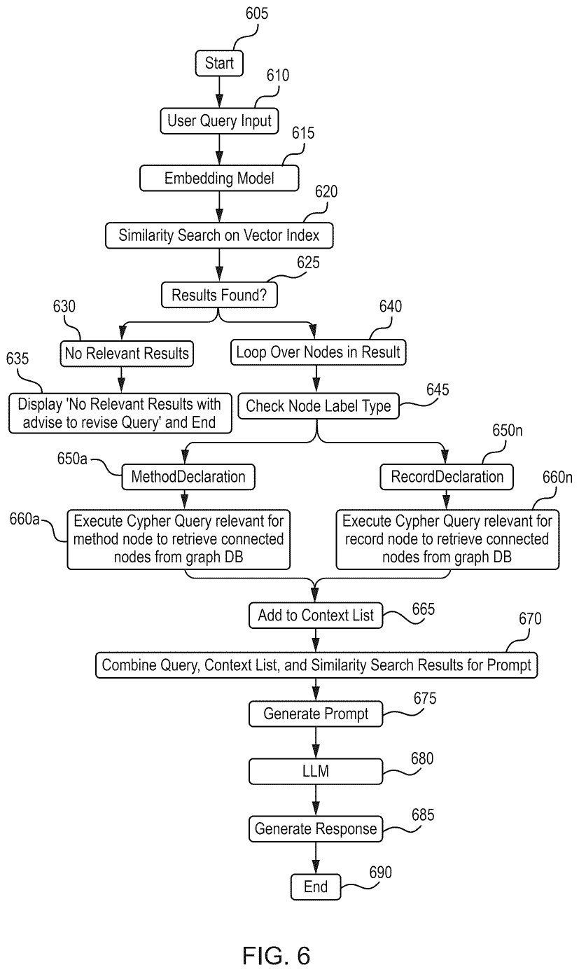

FIG. 6 shows an exemplary workflow for processing a user query. The workflow starts with initialization of an application (e.g., a codebase application associated with the AI-powered chatbot system implemented using an IaaS environment as described in detail herein) at block 605. At block 610, an utterance (e.g., a query) is input into an interface of the application by a user. In some instances, the utterance may pertain to a question or request that the user wishes to pose to the AI-powered chatbot system concerning a codebase. At block 615, the utterance is input into an embedding model and the embedding model generates an embedding for the utterance. The embedding model may be the same model (e.g., embed-english-v3.0 model) used in the codebase ingestion process. In some instances, prior to inputting the utterance into the embedding model the utterance is preprocessed (e.g., tokenization, removing stop words, etc.). The embedding model outputs a vector representation for the utterance or preprocessed utterance, which is the embedding.

At block 620, the embedding is used by the AI-powered chatbot system as a key for a similarity search executed on the vector index (e.g., the Neo-4jVector) generated as describe above in the codebase ingestion process. This search is a first part of a hybrid retrieval process (Retrieval-Augmented Generation (RAG)) to retrieve relevant parts of the codebase to be used by the AI-powered chatbot system for responding to the utterance. RAG is a hybrid machine learning approach that combines information retrieval with generative models to improve the quality and accuracy of generated responses. RAG works by first retrieving relevant information from an external knowledge base or repository (i.e., the codebase graph stored in a database and associated vector embeddings stored in a vector index) and then using that information to guide the generation of responses via one or more generative models. RAG uses the embedding of the utterance to perform the retrieval: graph data and queries are transformed into vector representations using a model (e.g., a embed-english-v3.0 model), and the similarity between these embeddings may be used to find the relevant nodes in the graph (see block 625). In some instances, the similarity search is performed using Neo-4jVector (vector index) from LangChain's Neo-4j integration, where the embedding for the utterance is compared with node embeddings to determine a similarity (e.g., cosine similarity) between the embedding for the utterance and each of the node embeddings.

At block 625, a determination is made as to whether the first part of a hybrid retrieval process was able to identify any relevant nodes in the graph. This determination can be made as part of a comparison of a calculated distance or similarity metric (e.g., cosine similarity) to a predetermined similarity threshold (e.g., node vector embeddings having a similarity to the utterance vector embedding greater than a predetermined similarity threshold are identified as the most relevant nodes). Once relevant information (e.g., the relevant nodes) is retrieved, it is typically provided as context to a generative model (e.g., an LLM) which uses this information to produce informed and contextually accurate responses. However, in accordance with the embodiments of this disclosure, the typical RAG process is modified (a second part of the hybrid retrieval process) to gather additional context for the relevant nodes from the graph database, such as function invocations, dependencies, and related files (see description for blocks 630-670). This hybrid retrieval process has been demonstrated to be particularly effective in scenarios where the generative model lacks code-specific knowledge or up-to-date information, as it integrates retrieval to ground its outputs in factual, contextual, external data. By integrating these technologies, a system is created that can effectively navigate and query codebases using natural language, ultimately empowering developers to extract insights and answers from complex source code efficiently.

At blocks 630 and 635, when there are no relevant nodes, a response is sent to the user that explains no relevant results have been found based on the utterance and advises the user to revise their utterance. In some instances, the response is displayed on the interface of the application. The workflow then ends. At blocks 640 and 645, when there are relevant nodes, each of the relevant nodes are analyzed in an iterative or loop process to identify types of constructs (e.g., the label of the node such as MethodDeclaration or RecordDeclaration) associated with the relevant nodes based on the properties and attributes (e.g., entities) of the relevant nodes in the schema file.

Once the one or more parameter or attribute types are identified, a query is generated at blocks 650a-650n for each of the relevant nodes based on types of constructs associated with each of the relevant nodes. Essentially, the AI-powered chatbot system generates graph queries to gather additional context for each of the relevant nodes. This includes generating queries to retrieve related functions, dependencies, and connected files. In some instances, the graph queries are cypher queries which can be run on the graph database (e.g., Neo-4j database) to gather additional context, such as function invocations, dependencies, and related files. A cypher query is a declarative graph query language that allows for expressive and efficient data querying in a property graph (e.g., CPG). At blocks 660a-660n, the queries generated for each of the relevant nodes are executed on the graph database (e.g., Neo-4j database) to gather the additional context, such as function invocations, dependencies, data flow between nodes, control flow around nodes, scope of the nodes in a given project, and related files based on the one or more parameter or attribute types associated with each of the relevant nodes. The graph-based retrieval enables the gathering of interconnected data important for answering queries such as the utterance. More specifically, the combination of similarity search and graph queries ensures a balance between precision and performance, making the AI-powered chatbot system both accurate and scalable for practical usage

At block 665, the properties or attributes for each of the relevant nodes (e.g., a method's name, return type, parameter types, code, and comments), the properties or attributes for edges that represent relationships between each of the relevant nodes and connected nodes in the graph such as invocation edges, and the additional context, such as function invocations, dependencies, and related files gathered in blocks 640 and 645, 650a-650n, and 660a-660n, are all added or compiled within a context list (e.g., a table, list, file, data storage or structure for the context) in association with each of the relevant nodes. For example, initially when a query is received it is used for semantic similarity between the query and name attribute of the nodes, and the nodes that have names similar to the query are obtained as the relevant nodes. Then using the graph query, all the relevant nodes and connected nodes are queried to obtain properties/attributes of the relevant nodes and the connected nodes. All the properties/attributes from the relevant nodes and connected nodes form the context list. At block 670, the utterance from block 610 and the context list from block 665 are combined into a single data structure.

At block 675, a prompt is generated for one or more generative models using the data structure comprising the utterance and the context list. A prompt is a natural language request that a generative model such as LLM uses to generate a response. Prompts can include instructions, questions, examples, and contextual information. The generative model can then generate text, images, code, videos, audio, and more based on the prompt. For example, when a user submits an utterance to the interface, the AI-powered chatbot system can automatically generate a prompt by combining the utterance with additional contextual information and similarity results derived from the relevant data sources (i.e., graph database and vector index). This involves constructing the prompt in a clear, organized, and structured format that effectively guides the generative model. The AI-powered chatbot system may prioritize elements based on their relevance or importance to the query, ensuring that the model focuses on the most critical aspects. Predefined templates or formatting rules can be used to maintain consistency and clarity, especially for use cases requiring structured outputs. For example, the prompt might include the utterance rephrased or expanded with retrieved contextual details and similarity results to provide the model with a well-rounded understanding of the request. This automated process not only streamlines user interactions with the generative model but also enhances the quality and relevance of the generated responses, enabling the AI-powered chatbot system to address complex queries more effectively.

At blocks 675, 680, and 685, the prompt is sent to one or more generative models (e.g., Cohere's LLM), which generates a detailed, context-aware response based on the utterance and the contextual code relationships. This ensures that users (e.g., developers) receive relevant answer to their query with code dependencies and connections, easing navigation of complex codebases. The response is then sent to the user. In some instances, the response is displayed on the interface of the application. The workflow then ends at block 690. This approach provides instant (real-time or substantially real-time) responses to any utterance related to the codebase. The responses help users navigate and understand complex codebases, which reduces the time and effort needed to explore large systems. Further, its 24/7 availability ensures users can get help whenever needed, significantly boosting productivity. Moreover, this approach responds in the context of the entire codebase, rather than isolated scripts. The approach is thus beneficial not just for developers but also for other types of users such as QEs and managers, aiding them in their tasks.

Follows are examples of responses generated using the above exemplary workflow, which illustrate the AI-powered chatbot system capabilities in answering queries about a codebase. The responses were generated using a GitHub repository containing approximately 55 classes, based on a train ticket reservation system.

### Questions With Keywords (Name of Api or Class):

1. What is the primary role of getTrainbyId?
   The ‘getTrainById‘ method is responsible for retrieving train information based on a given train ID or number. It is a part of the ‘getTrainById‘ interface and its implementation, ‘TrainServiceImpl‘, in a Java-based train reservation system.
   Here's the breakdown of its role:
**Method Signature:**—‘public TrainBean getTrainById(String trainNo) throws TrainException;‘
**Functionality:**—This method takes a ‘trainNo‘ (train ID or number) as input and returns a ‘TrainBean‘ object containing details about the train.—It performs a database query to fetch the train information based on the provided train number.—The method handles potential exceptions and returns a ‘TrainBean‘ object with the train's details, including fare, from station, to station, train name, train number, and available seats.
**Usage:**—The ‘getTrainById‘ method is used in various servlets and classes within the train reservation system, such as ‘AdminTrainUpdate‘, ‘AdminSearchTrain‘, ‘UserSearchTrain‘, ‘UserViewLinkGet‘, ‘UserAvailServlet‘, and ‘BookTrains‘.—It is crucial for retrieving train details, which are then used for displaying train information, updating train schedules, searching for trains, and booking tickets.
   In summary, the primary role of ‘getTrainById‘ is to fetch and provide train details based on a given train ID, enabling various functionalities in the train reservation system.
2. How is User Service Class Utilized in UserRegServlet?
   The ‘UserService‘ class is utilized in the ‘UserRegServlet‘ class for user registration functionality. Here's how it's used:
The ‘UserService‘ class is instantiated as a private field in the ‘UserRegServlet‘ class:

‘‘‘java private UserService userService = new UserServiceImpl(UserRole.CUSTOMER);
‘‘‘
- In the ‘doPost‘ method of ‘UserRegServlet‘, a ‘UserBean‘ object is created and
populated with user details from the HTTP request parameters.
‘‘‘java
UserBean user = new UserBean( );
user.setMailId(req.getParameter(″mailid″))
user.setPWord(req.getParameter(″pword″));
user.setFName(req.getParameter(″firstname″));
user.setLName(req.getParameter(″lastname″));
user.setAddr(req.getParameter(″address″));
user.setPhNo(Long.parseLong(req.getParameter(″phoneno″)));
‘‘‘

The ‘registerUser‘ method of the ‘userService‘ object is called, passing the ‘user‘ object as a parameter:

‘‘‘java
String message = userService.registerUser(user);
‘‘‘

The ‘registerUser‘ method is responsible for registering the user in the system, and it returns a message indicating the result of the registration process.
The code then checks the value of the ‘message‘ to determine whether the registration was successful or not, and displays an appropriate message to the user.
If the registration is successful, it includes the ‘UserLogin.html‘ page and displays a success message. Otherwise, it includes the ‘UserRegister.html‘ page and displays an error message.
So, the ‘UserService‘ class is used to handle the user registration process in the ‘UserRegServlet‘ class, providing a way to register new users and manage their data.

### Questions Without Keyword:

1. What is the purpose of admin train update class?
   The ‘AdminTrainUpdate‘ class in Java is designed to handle administrative tasks related to updating train schedules. It extends the ‘HttpServlet‘ class and is annotated with ‘@WebServlet(“/adminupdatetrain”)‘, indicating its role as a servlet that responds to specific web requests.
   Here's the purpose and functionality of the ‘AdminTrainUpdate‘ class:

### **1. URL Mapping:**

The ‘@WebServlet(“/adminupdatetrain”)‘ annotation maps this servlet to the URL path “/adminupdatetrain.” This means when a request is made to this URL, the methods in this class will be invoked to handle the request.

### **2. Train Service Dependency:**

The class has a private instance of ‘TrainService‘ named ‘trainService‘, which is used to interact with the train data. In this case, ‘TrainServiceImpl‘ is used as the implementation.
   **3. ‘doPost‘ Method: **—The ‘doPost‘ method is overridden to handle HTTP POST requests. It is responsible for updating the train schedule based on the provided parameters.
It sets the content type of the response to “text/html” and gets a ‘PrintWriter‘ to write the response.
It retrieves the train number from the request parameters using ‘req.getParameter(“trainnumber”)‘.
It then uses the ‘trainService‘ to get the train details by calling ‘trainService.getTrainById(trainNo)‘.
If the train is found, it includes the “AdminHome.html” page and displays a form with the train details, allowing the admin to update the schedule.
If the train is not found, it includes the “AdminUpdateTrain.html” page and displays a “Train Not Available” message.
The method also includes exception handling, throwing a ‘TrainException‘ in case of errors.
   **4. ‘doGet‘ Method:**
The ‘doGet‘ method simply delegates the request handling to the ‘doPost‘ method, ensuring that both GET and POST requests are handled in the same way.
   In summary, the ‘AdminTrainUpdate‘ class is an administrative servlet that allows authorized users (admins) to update train schedules. It retrieves train details based on the train number, displays a form with the current details, and provides functionality to update the schedule. The class interacts with the ‘TrainService‘ to fetch and update train data.
2. Who handles the logout process?
   The logout process is handled by the ‘TrainUtil‘ class, specifically through the ‘TrainUtil.logout(res)‘ method. This method is called in both the ‘UserLogoutServlet‘ and ‘AdminLogoutServlet‘ classes when a user or admin initiates the logout process.
   Here's a breakdown of the relevant classes and their roles:
‘UserLogoutServlet‘: This servlet handles user logout. It extends ‘HttpServlet‘ and is mapped to the URL “/userlogout”. When a GET request is made to this servlet, it checks if the user is logged in using ‘TrainUtil.isLoggedIn(req, UserRole.CUSTOMER)‘. If the user is logged in, it calls ‘TrainUtil.logout(res)‘ to perform the logout action, and then displays a success message. If the user is not logged in, it displays a message indicating that they are already logged out.
‘AdminLogoutServlet‘: Similar to ‘UserLogoutServlet‘, this servlet handles admin logout. It is mapped to the URL “/adminlogout”. It also checks if the admin is logged in using ‘TrainUtil.isLoggedIn(req, UserRole.ADMIN)‘ and performs the logout action using ‘TrainUtil.logout(res)‘ if they are logged in. Success and failure messages are displayed accordingly.
‘TrainUtil‘: This class seems to be a utility class that provides methods for login, logout, and checking login status. The ‘logout‘ method in this class is responsible for handling the actual logout process, as indicated by the method calls in the servlets.
   Based on the provided context, the ‘TrainUtil‘ class is the primary handler for the logout process, and it is invoked by both user and admin logout servlets.

### Conceptual Questions

1. How are exceptions handled in the codebase?
   The codebase handles exceptions using the ‘TrainException‘ class, which is a custom exception class extending ‘IOException‘.
   Here's how exceptions are handled:
The ‘TrainException‘ class has multiple constructors to create exceptions with different parameters:
   ‘TrainException(ResponseCode errorCodes)‘: This constructor takes a ‘ResponseCode‘ object and sets the error message, status code, and error code based on the provided ‘ResponseCode‘.
   ‘TrainException(int statusCode, String errorCode, String errorMessage)‘: This constructor allows setting the status code, error code, and error message directly.
   ‘TrainException(String errorMessage)‘: This constructor sets the error message and assigns default values for the status code and error code.
The ‘TrainException‘ class has getter and setter methods for the error code, error message, and status code, allowing easy access and modification of these properties.
In the ‘ErrorHandlerServlet‘ class the ‘service‘ method handles exceptions. It fetches the exception, status code, servlet name, and other relevant information from the request attributes. It then checks if the exception is an instance of ‘TrainException‘ and, if so, retrieves the error message, status code, and error code from the ‘TrainException‘ object.
The error details are then printed to the console for debugging purposes, and the error is displayed to the user based on the status code. If the status code is 401, a specific error message is included in the response. Otherwise, a generic error page is included.
The ‘TrainException‘ class is used in various servlets and utility classes throughout the codebase, as indicated by the ‘related_files‘ and ‘connected_record_files‘ fields in the context.
   This codebase employs a custom exception class, ‘TrainException‘, to handle exceptions related to train-related operations, providing a structured way to manage and display errors to users.
2. Suggest some ways to improve the implementation of train service?
   Based on the provided context, here are some suggestions to improve the implementation of the ‘TrainService‘:
1. **Error Handling and Exception Management**:
   In the ‘addTrain‘ method, when an exception occurs, the ‘responseCode‘ is set to ‘FAILURE‘ and the exception message is appended. Consider creating custom exception classes for different types of errors, such as database errors, validation errors, or train-specific errors. This will make the error handling more structured and meaningful.
   In the ‘getTrainById‘ method, a ‘TrainException‘ is thrown when a SQLException occurs. It might be beneficial to include more details in the exception message, such as the train ID being searched for, to provide better context during error handling.
2. **Database Query Optimization**:
   In the ‘getTrainsBetweenStations‘ method, the query uses a ‘LIKE‘ operator with ‘%‘ to match the station names. This can be inefficient for large datasets as it performs a full table scan. Consider using a full-text search index on the station columns or implementing a more optimized search algorithm to improve performance.
3. **Data Validation**:
   Before inserting or updating train data, validate the input parameters to ensure they meet the required criteria. For example, check if the train number is unique, validate the station names, and ensure the seat count and fare are within valid ranges. This will help prevent invalid data from being stored in the database.
4. **Transaction Management**:
   When performing multiple database operations, consider using transactions to ensure data integrity. For example, when updating a train's details, you can start a transaction, update the necessary fields, and then commit the changes. If any error occurs during the process, you can roll back the transaction to maintain data consistency.
5. **Separation of Concerns**:
   The ‘TrainServiceImpl‘ class seems to handle both business logic and database operations. Consider separating these concerns by introducing a data access layer (DAL) or repository pattern. This will make the code more modular, easier to test, and allow for better maintenance in the future.
6. **Pagination and Sorting**:
   When retrieving all trains using the ‘getAllTrains‘ method, consider implementing pagination to handle large datasets. This will improve performance and provide a better user experience when displaying train lists. Additionally, you can add sorting options to allow users to sort trains by name, number, or other relevant criteria.
7. **Logging and Monitoring**
   Implement logging mechanisms to track important events, errors, and database operations. This will help in debugging, performance monitoring, and identifying potential issues. You can use logging frameworks like Log4j or SLF4J to achieve this.
8. **Security Considerations**:
   Ensure that sensitive data, such as train schedules or passenger information, is protected. Implement access control mechanisms to restrict unauthorized access to certain operations or data. Use encryption for sensitive data storage and transmission.
9. **Unit Testing**:
   Write comprehensive unit tests for the ‘TrainService‘ methods to ensure their correctness and to catch any potential bugs. Test various scenarios, including edge cases and error conditions, to validate the behavior of the service.
      By implementing these suggestions, you can enhance the robustness, performance, and maintainability of the ‘TrainService‘ implementation. Remember to adapt these improvements based on the specific requirements and constraints of your project.
3. Are there any security vulnerabilities in the codebase?
   Based on the provided context, there are some potential security vulnerabilities in the codebase. Here are a few observations:
**Insecure Password Handling**: In the ‘ChangeUserPassword‘ servlet, the user's old password is directly compared with the stored password. This could be a security risk if the passwords are not properly hashed and salted. Storing passwords in plain text is a significant security vulnerability. It is recommended to use secure password hashing algorithms like bcrypt or Argon2 to store hashed passwords, and then compare the hashed values during authentication.
**Lack of Input Validation**: In various servlets like ‘UserLoginServlet‘, ‘AdminLogin‘, and ‘ChangeUserPassword‘, there seems to be a lack of input validation for user-provided data. It is crucial to validate and sanitize user input to prevent injection attacks, such as SQL injection or cross-site scripting (XSS). Ensure that all user inputs are properly validated and sanitized before using them in database queries or rendering them in HTML.
**Error Handling and Exception Disclosure**: The ‘ErrorHandlerServlet‘ attempts to handle errors and exceptions. However, it is important to be cautious when disclosing error messages to users, as they can reveal sensitive information about the system. In the current implementation, the ‘errorMessage‘ and ‘errorCode‘ variables are directly printed, which might expose internal details. Consider implementing a more secure error handling mechanism that provides generic error messages to users while logging detailed information for debugging purposes.
**Session Management**: The codebase includes servlets for user and admin login, logout, and session management. It is essential to ensure that session management is secure and follows best practices. Implement measures to protect against session fixation, session hijacking, and ensure that sessions are properly invalidated after logout.
**Database Connection Security**: The ‘DBUtil‘ class is responsible for database connections. Ensure that database credentials are securely stored and not hardcoded in the codebase. Use environment variables or external configuration files to store sensitive information. Additionally, implement connection pooling and secure communication protocols (e.g., SSL/TLS) for database connections.
**Access Control and Authorization**: The codebase includes different user roles (e.g., ‘UserRole.ADMIN‘, ‘UserRole.CUSTOMER‘). Ensure that access control and authorization mechanisms are properly implemented to restrict access to specific resources and functionalities based on user roles. These are some initial observations regarding potential security vulnerabilities in the codebase. It is recommended to conduct a thorough security review and apply appropriate security measures to mitigate these risks.

### Techniques for Using Conversational Artificial Intelligence to Understand and Manage Source Code Repositories

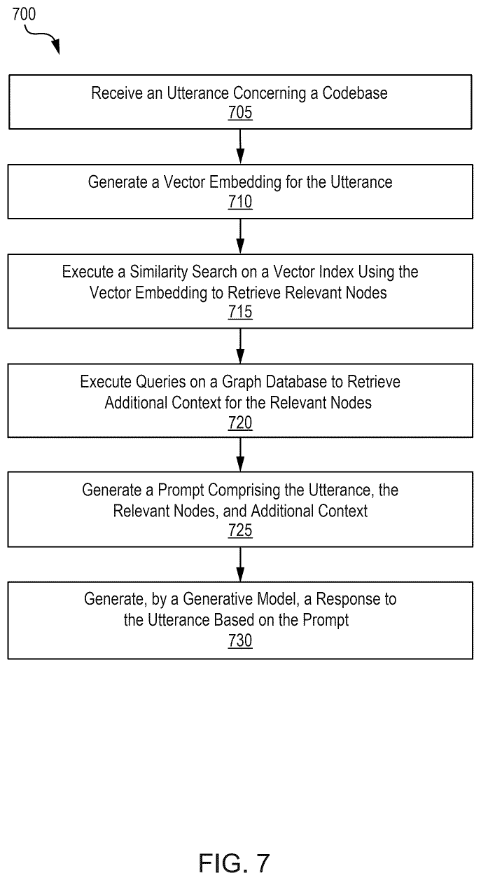

FIG. 7 depicts a simplified flowchart 700 illustrating a process for using conversational artificial intelligence to understand and manage source code repositories according to various embodiments. The processing depicted in FIG. 7 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 7 and described below is intended to be illustrative and non-limiting. Although FIG. 7 depicts the various processing steps occurring in a particular sequence or order, this is not intended to be limiting. In certain alternative embodiments, the steps may be performed in some different order, or some steps may also be performed in parallel. In various embodiments, the processing depicted in FIG. 7 may be performed by an AI-powered chatbot system, as described with respect to FIGS. 1-6 and 8-12.

The process commences in step 705, where an utterance concerning code in a codebase is received. The utterance may be received from a user. In some instances, the utterance is a query concerning a particular codebase such as a Java codebase. In some instances, the utterance is received via a user interface, and the user interface is part of an application associated with an AI-powered chatbot system.

At step 710, an utterance vector embedding is generated based on the utterance. In some instances, the utterance is input into an embedding model and the embedding model generates the utterance vector embedding. The embedding model may be the same model (e.g., embed-english-v3.0 model) used in the codebase ingestion process. In some instances, prior to inputting the utterance into the embedding model the utterance is preprocessed (e.g., tokenization, removing stop words, etc.). The embedding model outputs a vector representation for the utterance or preprocessed utterance, which is the utterance vector embedding.

At step 715, a similarity search (first part of hybrid retrieval process) is executed on a vector index by comparing the utterance vector embedding to vector embeddings stored in the vector index using a similarity metric and identifying relevant nodes in a graph-based representation of the codebase based on the comparing. Each of the vector embeddings stored in the vector index represent parameters or attributes of the code in a continuous vector space. Further, the parameters or attributes for each of the vector embeddings are associated with a node in the graph-based representation of the codebase.

In some instances, comparing the utterance vector embedding to the vector embeddings comprises: calculating the similarity metric between the utterance vector embedding and each of the vector embeddings, comparing the similarity metric between the utterance vector embedding and each of the vector embeddings to a predetermined similarity threshold, when the similarity metric is equal to or greater than the predetermined similarity, the node associated with the vector embedding is identified as a relevant node, and when the similarity metric is less than the predetermined similarity, the node associated with the vector embedding is identified as a non-relevant node.

At step 720, queries are executed on a graph database to retrieve additional context associated with the relevant nodes based on types of constructs associated with the relevant nodes. The graph database stores the graph-based representation of the codebase. In some instances (prior to executing the queries on the graph database), an iterative process is performed for each of the relevant nodes, which comprises: analyzing each of the relevant nodes; and identifying, based on the analyzing, the types of constructs associated with the relevant nodes.

In some instances, the types of constructs associated with the relevant nodes are node label types. In some instances, the queries executed on the graph database are graph queries. In some instances, the graph queries are executed for each of the types of constructs associated with the relevant nodes to retrieve the additional context associated with the relevant nodes. In some instances, the additional context includes connected nodes, function invocations, dependencies, and related files.

At step 725, a prompt is generated comprising the utterance, the relevant nodes, and the additional context associated with the relevant nodes. In some instances (prior to generating the prompt), the properties or attributes for each of the relevant nodes and connected nodes, the properties or attributes for edges that represent relationships between each of the relevant nodes and connected nodes in the graph-based representation of the codebase, and the additional context are compiled within a context list in association with each of the relevant nodes, and a data structure is generated comprising the utterance and the context list. In such instances, the prompt is generated using: (i) the data structure, and (ii) predefined templates, formatting rules, or a combination thereof.

At step 730, a response to the utterance is generated by a generative model based on the prompt. In some instances, the generative model is deployed on a platform and used via an application and/or system. In some instances, the generative model comprises a transformer network including of multiple layers containing a multi-head, self-attention mechanism and a position-wise, feed-forward network, the multi-head, self-attention mechanism is configured to enable parallel processing of input sequences from the prompt, allowing the generative model to simultaneously evaluate the importance of different segments of the input sequences relative to each other, the position-wise, feed-forward network includes two linear transformations with a non-linear activation function in between, and each element of the input sequences, enriched with context including the importance of different segments of the input sequences relative to each other by the multi-head, self-attention mechanism, is processed independently through the same feed-forward network.

In some instances, the response is displayed on the user interface such that the user can view the response. In other instances, the response is communicated to a different system or computing device for further processing.

### Illustrative Systems

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 8 is a block diagram 800 illustrating an example pattern of an IaaS architecture, according to at least one embodiment. Service operators 802 can be communicatively coupled to a secure host tenancy 804 that can include a virtual cloud network (VCN) 806 and a secure host subnet 808. In some examples, the service operators 802 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 806 and/or the Internet.

The VCN 806 can include a local peering gateway (LPG) 810 that can be communicatively coupled to a secure shell (SSH) VCN 812 via an LPG 810 contained in the SSH VCN 812. The SSH VCN 812 can include an SSH subnet 814, and the SSH VCN 812 can be communicatively coupled to a control plane VCN 816 via the LPG 810 contained in the control plane VCN 816. Also, the SSH VCN 812 can be communicatively coupled to a data plane VCN 818 via an LPG 810. The control plane VCN 816 and the data plane VCN 818 can be contained in a service tenancy 819 that can be owned and/or operated by the IaaS provider.

The control plane VCN 816 can include a control plane demilitarized zone (DMZ) tier 820 that acts as a perimeter network (e.g., portions of a corporate network between the corporate intranet and external networks). The DMZ-based servers may have restricted responsibilities and help keep breaches contained. Additionally, the DMZ tier 820 can include one or more load balancer (LB) subnet(s) 822, a control plane app tier 824 that can include app subnet(s) 826, a control plane data tier 828 that can include database (DB) subnet(s) 830 (e.g., frontend DB subnet(s) and/or backend DB subnet(s)). The LB subnet(s) 822 contained in the control plane DMZ tier 820 can be communicatively coupled to the app subnet(s) 826 contained in the control plane app tier 824 and an Internet gateway 834 that can be contained in the control plane VCN 816, and the app subnet(s) 826 can be communicatively coupled to the DB subnet(s) 830 contained in the control plane data tier 828 and a service gateway 836 and a network address translation (NAT) gateway 838. The control plane VCN 816 can include the service gateway 836 and the NAT gateway 838.

The control plane VCN 816 can include a data plane mirror app tier 840 that can include app subnet(s) 826. The app subnet(s) 826 contained in the data plane mirror app tier 840 can include a virtual network interface controller (VNIC) 842 that can execute a compute instance 844. The compute instance 844 can communicatively couple the app subnet(s) 826 of the data plane mirror app tier 840 to app subnet(s) 826 that can be contained in a data plane app tier 846.

The data plane VCN 818 can include the data plane app tier 846, a data plane DMZ tier 848, and a data plane data tier 850. The data plane DMZ tier 848 can include LB subnet(s) 822 that can be communicatively coupled to the app subnet(s) 826 of the data plane app tier 846 and the Internet gateway 834 of the data plane VCN 818. The app subnet(s) 826 can be communicatively coupled to the service gateway 836 of the data plane VCN 818 and the NAT gateway 838 of the data plane VCN 818. The data plane data tier 850 can also include the DB subnet(s) 830 that can be communicatively coupled to the app subnet(s) 826 of the data plane app tier 846.

The Internet gateway 834 of the control plane VCN 816 and of the data plane VCN 818 can be communicatively coupled to a metadata management service 852 that can be communicatively coupled to public Internet 854. Public Internet 854 can be communicatively coupled to the NAT gateway 838 of the control plane VCN 816 and of the data plane VCN 818. The service gateway 836 of the control plane VCN 816 and of the data plane VCN 818 can be communicatively coupled to cloud services 856.

In some examples, the service gateway 836 of the control plane VCN 816 or of the data plane VCN 818 can make application programming interface (API) calls to cloud services 856 without going through public Internet 854. The API calls to cloud services 856 from the service gateway 836 can be one-way: the service gateway 836 can make API calls to cloud services 856, and cloud services 856 can send requested data to the service gateway 836. But, cloud services 856 may not initiate API calls to the service gateway 836.

In some examples, the secure host tenancy 804 can be directly connected to the service tenancy 819, which may be otherwise isolated. The secure host subnet 808 can communicate with the SSH subnet 814 through an LPG 810 that may enable two-way communication over an otherwise isolated system. Connecting the secure host subnet 808 to the SSH subnet 814 may give the secure host subnet 808 access to other entities within the service tenancy 819.

The control plane VCN 816 may allow users of the service tenancy 819 to set up or otherwise provision desired resources. Desired resources provisioned in the control plane VCN 816 may be deployed or otherwise used in the data plane VCN 818. In some examples, the control plane VCN 816 can be isolated from the data plane VCN 818, and the data plane mirror app tier 840 of the control plane VCN 816 can communicate with the data plane app tier 846 of the data plane VCN 818 via VNICs 842 that can be contained in the data plane mirror app tier 840 and the data plane app tier 846.

In some examples, users of the system, or customers, can make requests, for example create, read, update, or delete (CRUD) operations, through public Internet 854 that can communicate the requests to the metadata management service 852. The metadata management service 852 can communicate the request to the control plane VCN 816 through the Internet gateway 834. The request can be received by the LB subnet(s) 822 contained in the control plane DMZ tier 820. The LB subnet(s) 822 may determine that the request is valid, and in response to this determination, the LB subnet(s) 822 can transmit the request to app subnet(s) 826 contained in the control plane app tier 824. If the request is validated and requires a call to public Internet 854, the call to public Internet 854 may be transmitted to the NAT gateway 838 that can make the call to public Internet 854. Metadata that may be desired to be stored by the request can be stored in the DB subnet(s) 830.

In some examples, the data plane mirror app tier 840 can facilitate direct communication between the control plane VCN 816 and the data plane VCN 818. For example, changes, updates, or other suitable modifications to configuration may be desired to be applied to the resources contained in the data plane VCN 818. Via a VNIC 842, the control plane VCN 816 can directly communicate with, and can thereby execute the changes, updates, or other suitable modifications to configuration to, resources contained in the data plane VCN 818.

In some embodiments, the control plane VCN 816 and the data plane VCN 818 can be contained in the service tenancy 819. In this case, the user, or the customer, of the system may not own or operate either the control plane VCN 816 or the data plane VCN 818. Instead, the IaaS provider may own or operate the control plane VCN 816 and the data plane VCN 818, both of which may be contained in the service tenancy 819. This embodiment can enable isolation of networks that may prevent users or customers from interacting with other users', or other customers', resources. Also, this embodiment may allow users or customers of the system to store databases privately without needing to rely on public Internet 854, which may not have a desired level of threat prevention, for storage.

In other embodiments, the LB subnet(s) 822 contained in the control plane VCN 816 can be configured to receive a signal from the service gateway 836. In this embodiment, the control plane VCN 816 and the data plane VCN 818 may be configured to be called by a customer of the IaaS provider without calling public Internet 854. Customers of the IaaS provider may desire this embodiment since database(s) that the customers use may be controlled by the IaaS provider and may be stored on the service tenancy 819, which may be isolated from public Internet 854.

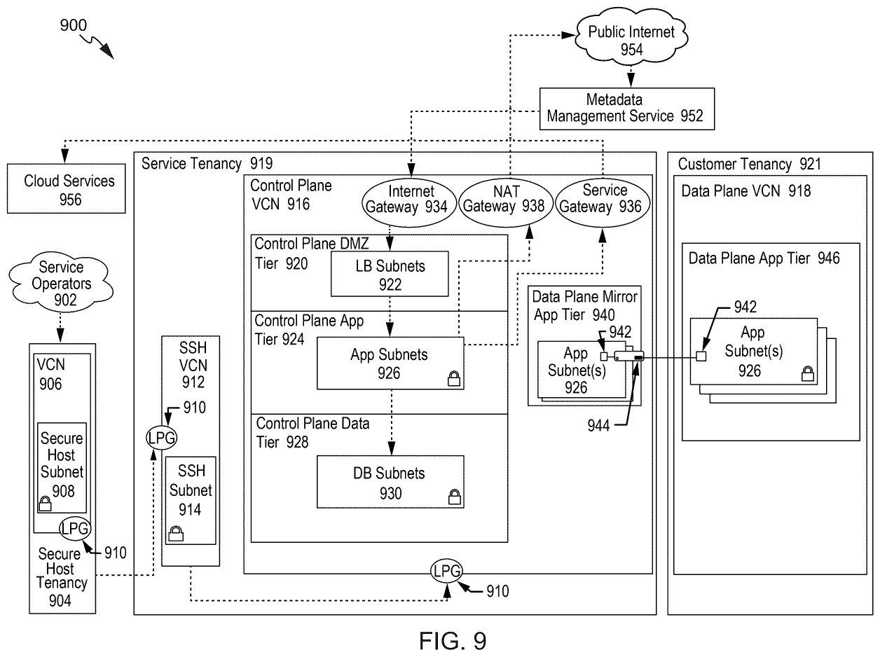

FIG. 9 is a block diagram 900 illustrating another example pattern of an IaaS architecture, according to at least one embodiment. Service operators 902 (e.g., service operators 802 of FIG. 8) can be communicatively coupled to a secure host tenancy 904 (e.g., the secure host tenancy 804 of FIG. 8) that can include a virtual cloud network (VCN) 906 (e.g., the VCN 806 of FIG. 8) and a secure host subnet 908 (e.g., the secure host subnet 808 of FIG. 8). The VCN 906 can include a local peering gateway (LPG) 910 (e.g., the LPG 810 of FIG. 8) that can be communicatively coupled to a secure shell (SSH) VCN 912 (e.g., the SSH VCN 812 of FIG. 8) via an LPG 810 contained in the SSH VCN 912. The SSH VCN 912 can include an SSH subnet 914 (e.g., the SSH subnet 814 of FIG. 8), and the SSH VCN 912 can be communicatively coupled to a control plane VCN 916 (e.g., the control plane VCN 816 of FIG. 8) via an LPG 910 contained in the control plane VCN 916. The control plane VCN 916 can be contained in a service tenancy 919 (e.g., the service tenancy 819 of FIG. 8), and the data plane VCN 918 (e.g., the data plane VCN 818 of FIG. 8) can be contained in a customer tenancy 921 that may be owned or operated by users, or customers, of the system.

The control plane VCN 916 can include a control plane DMZ tier 920 (e.g., the control plane DMZ tier 820 of FIG. 8) that can include LB subnet(s) 922 (e.g., LB subnet(s) 822 of FIG. 8), a control plane app tier 924 (e.g., the control plane app tier 824 of FIG. 8) that can include app subnet(s) 926 (e.g., app subnet(s) 826 of FIG. 8), a control plane data tier 928 (e.g., the control plane data tier 828 of FIG. 8) that can include database (DB) subnet(s) 930 (e.g., similar to DB subnet(s) 830 of FIG. 8). The LB subnet(s) 922 contained in the control plane DMZ tier 920 can be communicatively coupled to the app subnet(s) 926 contained in the control plane app tier 924 and an Internet gateway 934 (e.g., the Internet gateway 834 of FIG. 8) that can be contained in the control plane VCN 916, and the app subnet(s) 926 can be communicatively coupled to the DB subnet(s) 930 contained in the control plane data tier 928 and a service gateway 936 (e.g., the service gateway 836 of FIG. 8) and a network address translation (NAT) gateway 938 (e.g., the NAT gateway 838 of FIG. 8). The control plane VCN 916 can include the service gateway 936 and the NAT gateway 938.

The control plane VCN 916 can include a data plane mirror app tier 940 (e.g., the data plane mirror app tier 840 of FIG. 8) that can include app subnet(s) 926. The app subnet(s) 926 contained in the data plane mirror app tier 940 can include a virtual network interface controller (VNIC) 942 (e.g., the VNIC of 842) that can execute a compute instance 944 (e.g., similar to the compute instance 844 of FIG. 8). The compute instance 944 can facilitate communication between the app subnet(s) 926 of the data plane mirror app tier 940 and the app subnet(s) 926 that can be contained in a data plane app tier 946 (e.g., the data plane app tier 846 of FIG. 8) via the VNIC 942 contained in the data plane mirror app tier 940 and the VNIC 942 contained in the data plane app tier 946.

The Internet gateway 934 contained in the control plane VCN 916 can be communicatively coupled to a metadata management service 952 (e.g., the metadata management service 852 of FIG. 8) that can be communicatively coupled to public Internet 954 (e.g., public Internet 854 of FIG. 8). Public Internet 954 can be communicatively coupled to the NAT gateway 938 contained in the control plane VCN 916. The service gateway 936 contained in the control plane VCN 916 can be communicatively coupled to cloud services 956 (e.g., cloud services 856 of FIG. 8).

In some examples, the data plane VCN 918 can be contained in the customer tenancy 921. In this case, the IaaS provider may provide the control plane VCN 916 for each customer, and the IaaS provider may, for each customer, set up a unique compute instance 944 that is contained in the service tenancy 919. Each compute instance 944 may allow communication between the control plane VCN 916, contained in the service tenancy 919, and the data plane VCN 918 that is contained in the customer tenancy 921. The compute instance 944 may allow resources, that are provisioned in the control plane VCN 916 that is contained in the service tenancy 919, to be deployed or otherwise used in the data plane VCN 918 that is contained in the customer tenancy 921.

In other examples, the customer of the IaaS provider may have databases that live in the customer tenancy 921. In this example, the control plane VCN 916 can include the data plane mirror app tier 940 that can include app subnet(s) 926. The data plane mirror app tier 940 can reside in the data plane VCN 918, but the data plane mirror app tier 940 may not live in the data plane VCN 918. That is, the data plane mirror app tier 940 may have access to the customer tenancy 921, but the data plane mirror app tier 940 may not exist in the data plane VCN 918 or be owned or operated by the customer of the IaaS provider. The data plane mirror app tier 940 may be configured to make calls to the data plane VCN 918 but may not be configured to make calls to any entity contained in the control plane VCN 916. The customer may desire to deploy or otherwise use resources in the data plane VCN 918 that are provisioned in the control plane VCN 916, and the data plane mirror app tier 940 can facilitate the desired deployment, or other usage of resources, of the customer.

In some embodiments, the customer of the IaaS provider can apply filters to the data plane VCN 918. In this embodiment, the customer can determine what the data plane VCN 918 can access, and the customer may restrict access to public Internet 954 from the data plane VCN 918. The IaaS provider may not be able to apply filters or otherwise control access of the data plane VCN 918 to any outside networks or databases. Applying filters and controls by the customer onto the data plane VCN 918, contained in the customer tenancy 921, can help isolate the data plane VCN 918 from other customers and from public Internet 954.

In some embodiments, cloud services 956 can be called by the service gateway 936 to access services that may not exist on public Internet 954, on the control plane VCN 916, or on the data plane VCN 918. The connection between cloud services 956 and the control plane VCN 916 or the data plane VCN 918 may not be live or continuous. Cloud services 956 may exist on a different network owned or operated by the IaaS provider. Cloud services 956 may be configured to receive calls from the service gateway 936 and may be configured to not receive calls from public Internet 954. Some cloud services 956 may be isolated from other cloud services 956, and the control plane VCN 916 may be isolated from cloud services 956 that may not be in the same region as the control plane VCN 916. For example, the control plane VCN 916 may be located in “Region 1,” and cloud service “Deployment 8,” may be located in Region 1 and in “Region 2.” If a call to Deployment 8 is made by the service gateway 936 contained in the control plane VCN 916 located in Region 1, the call may be transmitted to Deployment 8 in Region 1. In this example, the control plane VCN 916, or Deployment 8 in Region 1, may not be communicatively coupled to, or otherwise in communication with, Deployment 8 in Region 2.

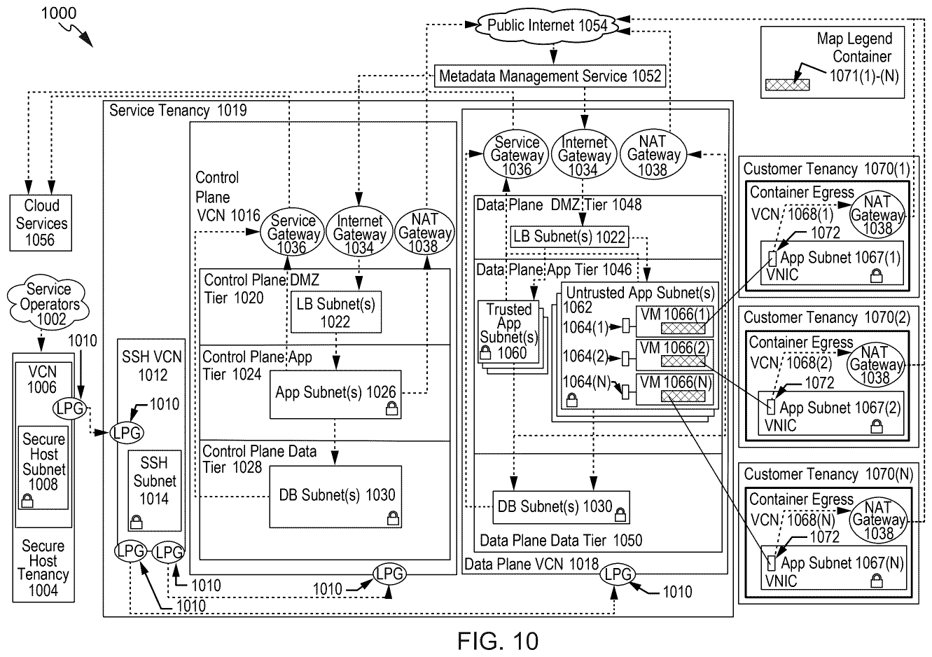

FIG. 10 is a block diagram 1000 illustrating another example pattern of an IaaS architecture, according to at least one embodiment. Service operators 1002 (e.g., service operators 802 of FIG. 8) can be communicatively coupled to a secure host tenancy 1004 (e.g., the secure host tenancy 804 of FIG. 8) that can include a virtual cloud network (VCN) 1006 (e.g., the VCN 806 of FIG. 8) and a secure host subnet 1008 (e.g., the secure host subnet 808 of FIG. 8). The VCN 1006 can include an LPG 1010 (e.g., the LPG 810 of FIG. 8) that can be communicatively coupled to an SSH VCN 1012 (e.g., the SSH VCN 812 of FIG. 8) via an LPG 1010 contained in the SSH VCN 1012. The SSH VCN 1012 can include an SSH subnet 1014 (e.g., the SSH subnet 814 of FIG. 8), and the SSH VCN 1012 can be communicatively coupled to a control plane VCN 1016 (e.g., the control plane VCN 816 of FIG. 8) via an LPG 1010 contained in the control plane VCN 1016 and to a data plane VCN 1018 (e.g., the data plane 818 of FIG. 8) via an LPG 1010 contained in the data plane VCN 1018. The control plane VCN 1016 and the data plane VCN 1018 can be contained in a service tenancy 1019 (e.g., the service tenancy 819 of FIG. 8).

The control plane VCN 1016 can include a control plane DMZ tier 1020 (e.g., the control plane DMZ tier 820 of FIG. 8) that can include load balancer (LB) subnet(s) 1022 (e.g., LB subnet(s) 822 of FIG. 8), a control plane app tier 1024 (e.g., the control plane app tier 824 of FIG. 8) that can include app subnet(s) 1026 (e.g., similar to app subnet(s) 826 of FIG. 8), a control plane data tier 1028 (e.g., the control plane data tier 828 of FIG. 8) that can include DB subnet(s) 1030. The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 834 of FIG. 8) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 8) and a network address translation (NAT) gateway 1038 (e.g., the NAT gateway 838 of FIG. 8). The control plane VCN 1016 can include the service gateway 1036 and the NAT gateway 1038.

The data plane VCN 1018 can include a data plane app tier 1046 (e.g., the data plane app tier 846 of FIG. 8), a data plane DMZ tier 1048 (e.g., the data plane DMZ tier 848 of FIG. 8), and a data plane data tier 1050 (e.g., the data plane data tier 850 of FIG. 8). The data plane DMZ tier 1048 can include LB subnet(s) 1022 that can be communicatively coupled to trusted app subnet(s) 1060 and untrusted app subnet(s) 1062 of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include one or more primary VNICs 1064(1)-(N) that can be communicatively coupled to tenant virtual machines (VMs) 1066(1)-(N). Each tenant VM 1066(1)-(N) can be communicatively coupled to a respective app subnet 1067(1)-(N) that can be contained in respective container egress VCNs 1068(1)-(N) that can be contained in respective customer tenancies 1070(1)-(N). Respective secondary VNICs 1072(1)-(N) can facilitate communication between the untrusted app subnet(s) 1062 contained in the data plane VCN 1018 and the app subnet contained in the container egress VCNs 1068(1)-(N). Each container egress VCNs 1068(1)-(N) can include a NAT gateway 1038 that can be communicatively coupled to public Internet 1054 (e.g., public Internet 854 of FIG. 8).

The Internet gateway 1034 contained in the control plane VCN 1016 and contained in the data plane VCN 1018 can be communicatively coupled to a metadata management service 1052 (e.g., the metadata management system 852 of FIG. 8) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively coupled to cloud services 1056.

In some embodiments, the data plane VCN 1018 can be integrated with customer tenancies 1070. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1046. Code to run the function may be executed in the VMs 1066(1)-(N), and the code may not be configured to run anywhere else on the data plane VCN 1018. Each VM 1066(1)-(N) may be connected to one customer tenancy 1070. Respective containers 1071(1)-(N) contained in the VMs 1066(1)-(N) may be configured to run the code. In this case, there can be a dual isolation (e.g., the containers 1071(1)-(N) running code, where the containers 1071(1)-(N) may be contained in at least the VM 1066(1)-(N) that are contained in the untrusted app subnet(s) 1062), which may help prevent incorrect or otherwise undesirable code from damaging the network of the IaaS provider or from damaging a network of a different customer. The containers 1071(1)-(N) may be communicatively coupled to the customer tenancy 1070 and may be configured to transmit or receive data from the customer tenancy 1070. The containers 1071(1)-(N) may not be configured to transmit or receive data from any other entity in the data plane VCN 1018. Upon completion of running the code, the IaaS provider may kill or otherwise dispose of the containers 1071(1)-(N).

In some embodiments, the trusted app subnet(s) 1060 may run code that may be owned or operated by the IaaS provider. In this embodiment, the trusted app subnet(s) 1060 may be communicatively coupled to the DB subnet(s) 1030 and be configured to execute CRUD operations in the DB subnet(s) 1030. The untrusted app subnet(s) 1062 may be communicatively coupled to the DB subnet(s) 1030, but in this embodiment, the untrusted app subnet(s) may be configured to execute read operations in the DB subnet(s) 1030. The containers 1071(1)-(N) that can be contained in the VM 1066(1)-(N) of each customer and that may run code from the customer may not be communicatively coupled with the DB subnet(s) 1030.

In other embodiments, the control plane VCN 1016 and the data plane VCN 1018 may not be directly communicatively coupled. In this embodiment, there may be no direct communication between the control plane VCN 1016 and the data plane VCN 1018. However, communication can occur indirectly through at least one method. An LPG 1010 may be established by the IaaS provider that can facilitate communication between the control plane VCN 1016 and the data plane VCN 1018. In another example, the control plane VCN 1016 or the data plane VCN 1018 can make a call to cloud services 1056 via the service gateway 1036. For example, a call to cloud services 1056 from the control plane VCN 1016 can include a request for a service that can communicate with the data plane VCN 1018.

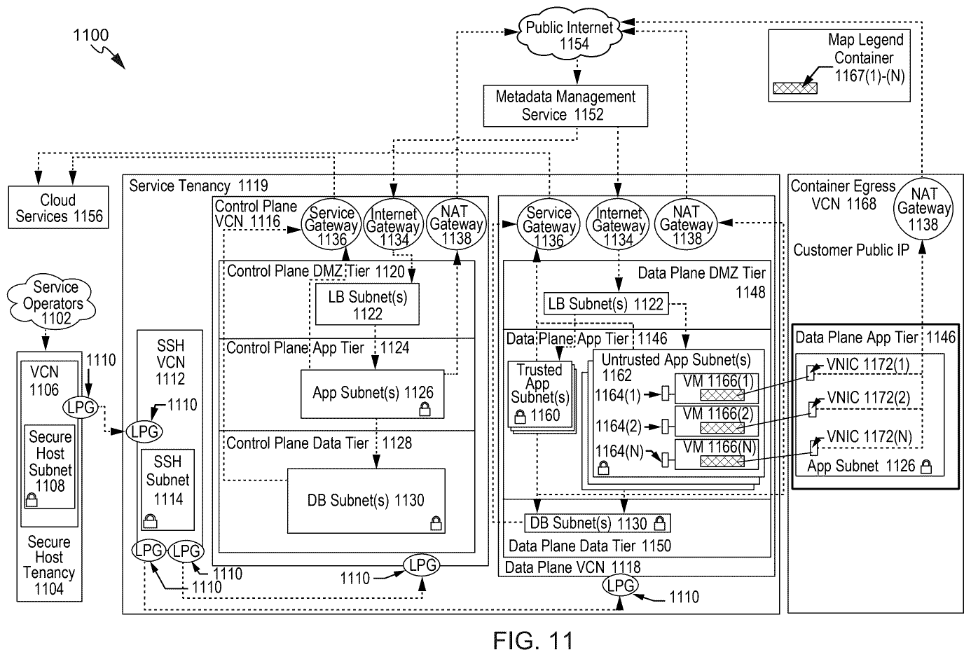

FIG. 11 is a block diagram 1100 illustrating another example pattern of an IaaS architecture, according to at least one embodiment. Service operators 1102 (e.g., service operators 802 of FIG. 8) can be communicatively coupled to a secure host tenancy 1104 (e.g., the secure host tenancy 804 of FIG. 8) that can include a virtual cloud network (VCN) 1106 (e.g., the VCN 806 of FIG. 8) and a secure host subnet 1108 (e.g., the secure host subnet 808 of FIG. 8). The VCN 1106 can include an LPG 1110 (e.g., the LPG 810 of FIG. 8) that can be communicatively coupled to an SSH VCN 1112 (e.g., the SSH VCN 812 of FIG. 8) via an LPG 1110 contained in the SSH VCN 1112. The SSH VCN 1112 can include an SSH subnet 1114 (e.g., the SSH subnet 814 of FIG. 8), and the SSH VCN 1112 can be communicatively coupled to a control plane VCN 1116 (e.g., the control plane VCN 816 of FIG. 8) via an LPG 1110 contained in the control plane VCN 1116 and to a data plane VCN 1118 (e.g., the data plane 818 of FIG. 8) via an LPG 1110 contained in the data plane VCN 1118. The control plane VCN 1116 and the data plane VCN 1118 can be contained in a service tenancy 1119 (e.g., the service tenancy 819 of FIG. 8).

The control plane VCN 1116 can include a control plane DMZ tier 1120 (e.g., the control plane DMZ tier 820 of FIG. 8) that can include LB subnet(s) 1122 (e.g., LB subnet(s) 822 of FIG. 8), a control plane app tier 1124 (e.g., the control plane app tier 824 of FIG. 8) that can include app subnet(s) 1126 (e.g., app subnet(s) 826 of FIG. 8), a control plane data tier 1128 (e.g., the control plane data tier 828 of FIG. 8) that can include DB subnet(s) 1130 (e.g., DB subnet(s) 1030 of FIG. 10). The LB subnet(s) 1122 contained in the control plane DMZ tier 1120 can be communicatively coupled to the app subnet(s) 1126 contained in the control plane app tier 1124 and to an Internet gateway 1134 (e.g., the Internet gateway 834 of FIG. 8) that can be contained in the control plane VCN 1116, and the app subnet(s) 1126 can be communicatively coupled to the DB subnet(s) 1130 contained in the control plane data tier 1128 and to a service gateway 1136 (e.g., the service gateway of FIG. 8) and a network address translation (NAT) gateway 1138 (e.g., the NAT gateway 838 of FIG. 8). The control plane VCN 1116 can include the service gateway 1136 and the NAT gateway 1138.

The data plane VCN 1118 can include a data plane app tier 1146 (e.g., the data plane app tier 846 of FIG. 8), a data plane DMZ tier 1148 (e.g., the data plane DMZ tier 848 of FIG. 8), and a data plane data tier 1150 (e.g., the data plane data tier 850 of FIG. 8). The data plane DMZ tier 1148 can include LB subnet(s) 1122 that can be communicatively coupled to trusted app subnet(s) 1160 (e.g., trusted app subnet(s) 1060 of FIG. 10) and untrusted app subnet(s) 1162 (e.g., untrusted app subnet(s) 1062 of FIG. 10) of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include primary VNICs 1164(1)-(N) that can be communicatively coupled to tenant virtual machines (VMs) 1166(1)-(N) residing within the untrusted app subnet(s) 1162. Each tenant VM 1166(1)-(N) can run code in a respective container 1167(1)-(N), and be communicatively coupled to an app subnet 1126 that can be contained in a data plane app tier 1146 that can be contained in a container egress VCN 1168. Respective secondary VNICs 1172(1)-(N) can facilitate communication between the untrusted app subnet(s) 1162 contained in the data plane VCN 1118 and the app subnet contained in the container egress VCN 1168. The container egress VCN can include a NAT gateway 1138 that can be communicatively coupled to public Internet 1154 (e.g., public Internet 854 of FIG. 8).

The Internet gateway 1134 contained in the control plane VCN 1116 and contained in the data plane VCN 1118 can be communicatively coupled to a metadata management service 1152 (e.g., the metadata management system 852 of FIG. 8) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively coupled to cloud services 1156.

In some examples, the pattern illustrated by the architecture of block diagram 1100 of FIG. 11 may be considered an exception to the pattern illustrated by the architecture of block diagram 1000 of FIG. 10 and may be desirable for a customer of the IaaS provider if the IaaS provider cannot directly communicate with the customer (e.g., a disconnected region). The respective containers 1167(1)-(N) that are contained in the VMs 1166(1)-(N) for each customer can be accessed in real-time by the customer. The containers 1167(1)-(N) may be configured to make calls to respective secondary VNICs 1172(1)-(N) contained in app subnet(s) 1126 of the data plane app tier 1146 that can be contained in the container egress VCN 1168. The secondary VNICs 1172(1)-(N) can transmit the calls to the NAT gateway 1138 that may transmit the calls to public Internet 1154. In this example, the containers 1167(1)-(N) that can be accessed in real-time by the customer can be isolated from the control plane VCN 1116 and can be isolated from other entities contained in the data plane VCN 1118. The containers 1167(1)-(N) may also be isolated from resources from other customers.

In other examples, the customer can use the containers 1167(1)-(N) to call cloud services 1156. In this example, the customer may run code in the containers 1167(1)-(N) that requests a service from cloud services 1156. The containers 1167(1)-(N) can transmit this request to the secondary VNICs 1172(1)-(N) that can transmit the request to the NAT gateway that can transmit the request to public Internet 1154. Public Internet 1154 can transmit the request to LB subnet(s) 1122 contained in the control plane VCN 1116 via the Internet gateway 1134. In response to determining the request is valid, the LB subnet(s) can transmit the request to app subnet(s) 1126 that can transmit the request to cloud services 1156 via the service gateway 1136.

It should be appreciated that IaaS architectures 800, 900, 1000, 1100 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

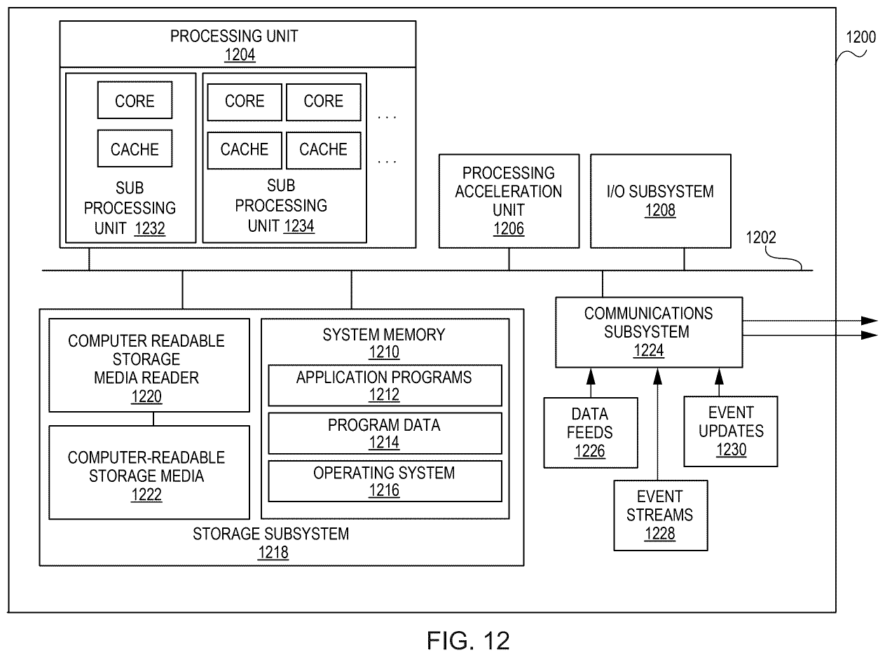

FIG. 12 illustrates an example computer system 1200, in which various embodiments may be implemented. The system 1200 may be used to implement any of the computer systems described above. As shown in the figure, computer system 1200 includes a processing unit 1204 that communicates with a number of peripheral subsystems via a bus subsystem 1202. These peripheral subsystems may include a processing acceleration unit 1206, an I/O subsystem 1208, a storage subsystem 1218 and a communications subsystem 1224. Storage subsystem 1218 includes tangible computer-readable storage media 1222 and a system memory 1210.

Bus subsystem 1202 provides a mechanism for letting the various components and subsystems of computer system 1200 communicate with each other as intended. Although bus subsystem 1202 is shown schematically as a single bus, alternative embodiments of the bus subsystem may utilize multiple buses. Bus subsystem 1202 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1204, which can be implemented as one or more integrated circuits (e.g., a conventional microprocessor or microcontroller), controls the operation of computer system 1200. One or more processors may be included in processing unit 1204. These processors may include single core or multicore processors. In certain embodiments, processing unit 1204 may be implemented as one or more independent processing units 1232 and/or 1234 with single or multicore processors included in each processing unit. In other embodiments, processing unit 1204 may also be implemented as a quad-core processing unit formed by integrating two dual-core processors into a single chip.

In various embodiments, processing unit 1204 can execute a variety of programs in response to program code and can maintain multiple concurrently executing programs or processes. At any given time, some or all of the program code to be executed can be resident in processor(s) 1204 and/or in storage subsystem 1218. Through suitable programming, processor(s) 1204 can provide various functionalities described above. Computer system 1200 may additionally include a processing acceleration unit 1206, which can include a digital signal processor (DSP), a special-purpose processor, and/or the like.

I/O subsystem 1208 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1200 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1200 may comprise a storage subsystem 1218 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1204 provide the functionality described above. Storage subsystem 1218 may also provide a repository for storing data used in accordance with the present disclosure.

As depicted in the example in FIG. 12, storage subsystem 1218 can include various components including a system memory 1210, computer-readable storage media 1222, and a computer readable storage media reader 1220. System memory 1210 may store program instructions that are loadable and executable by processing unit 1204. System memory 1210 may also store data that is used during the execution of the instructions and/or data that is generated during the execution of the program instructions. Various different kinds of programs may be loaded into system memory 1210 including but not limited to client applications, Web browsers, mid-tier applications, relational database management systems (RDBMS), virtual machines, containers, etc.

System memory 1210 may also store an operating system 1216. Examples of operating system 1216 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1200 executes one or more virtual machines, the virtual machines along with their guest operating systems (GOSs) may be loaded into system memory 1210 and executed by one or more processors or cores of processing unit 1204.

System memory 1210 can come in different configurations depending upon the type of computer system 1200. For example, system memory 1210 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1210 may include a basic input/output system (BIOS) containing basic routines that help to transfer information between elements within computer system 1200, such as during start-up.

Computer-readable storage media 1222 may represent remote, local, fixed, and/or removable storage devices plus storage media for temporarily and/or more permanently containing, storing, computer-readable information for use by computer system 1200 including instructions executable by processing unit 1204 of computer system 1200.

Computer-readable storage media 1222 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1222 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1222 may include, but is not limited to, Zip® drives, flash memory cards, universal serial bus (USB) flash drives, secure digital (SD) cards, DVD disks, digital video tape, and the like. Computer-readable storage media 1222 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1200.

Machine-readable instructions executable by one or more processors or cores of processing unit 1204 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1224 provides an interface to other computer systems and networks. Communications subsystem 1224 serves as an interface for receiving data from and transmitting data to other systems from computer system 1200. For example, communications subsystem 1224 may enable computer system 1200 to connect to one or more devices via the Internet. In some embodiments communications subsystem 1224 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1224 can provide wired network connectivity (e.g., Ethernet) in addition to or instead of a wireless interface.

In some embodiments, communications subsystem 1224 may also receive input communication in the form of structured and/or unstructured data feeds 1226, event streams 1228, event updates 1230, and the like on behalf of one or more users who may use computer system 1200.

By way of example, communications subsystem 1224 may be configured to receive data feeds 1226 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1224 may also be configured to receive data in the form of continuous data streams, which may include event streams 1228 of real-time events and/or event updates 1230, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1224 may also be configured to output the structured and/or unstructured data feeds 1226, event streams 1228, event updates 1230, and the like to one or more databases that may be in communication with one or more streaming data source computers coupled to computer system 1200.

Computer system 1200 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1200 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

1. A computer-implemented method comprising:
receiving an utterance concerning code in a codebase;
generating an utterance vector embedding based on the utterance;
executing a similarity search on a vector index by comparing the utterance vector embedding to vector embeddings stored in the vector index using a similarity metric and identifying relevant nodes in a graph-based representation of the codebase based on the comparing, wherein each of the vector embeddings stored in the vector index represent parameters or attributes of the code in a continuous vector space, and wherein the parameters or attributes for each of the vector embeddings are associated with a node in the graph-based representation of the codebase;
executing, based on types of constructs associated with the relevant nodes, queries on a graph database to retrieve additional context associated with the relevant nodes, wherein the graph database stores the graph-based representation of the codebase;
generating a prompt comprising the utterance, the relevant nodes, and the additional context associated with the relevant nodes; and
generating, by a generative model, a response to the utterance based on the prompt,
wherein the comparing the utterance vector embedding to the vector embeddings further includes:
calculating the similarity metric between the utterance vector embedding and each of the vector embeddings.
comparing the similarity metric between the utterance vector embedding and each of the vector embeddings to a predetermined similarity threshold,
when the similarity metric is equal to or greater than the predetermined similarity threshold, the node associated with the utterance vector embedding is identified as the relevant node, and
when the similarity metric is less than the predetermined similarity threshold, the node associated with the utterance vector embedding is identified as a non-relevant node.

2. (canceled)

3. The computer-implemented method of claim 1, further comprising performing an iterative process for each of the relevant nodes, the performing the iterative process comprising:
analyzing each of the relevant nodes; and
identifying, based on the analyzing, the types of constructs associated with the relevant nodes.

4. The computer-implemented method of claim 3, wherein:
the types of constructs associated with the relevant nodes are node label types;
the queries executed on the graph database are graph queries;
the graph queries are executed for each of the types of constructs associated with the relevant nodes to retrieve the additional context associated with the relevant nodes; and
the additional context includes connected nodes, function invocations, dependencies, and related files.

5. The computer-implemented method of claim 4, further comprising:
compiling properties or attributes for each of the relevant nodes and connected nodes, the properties or attributes for edges that represent relationships between each of the relevant nodes and the connected nodes in the graph-based representation of the codebase, and the additional context within a context list in association with each of the relevant nodes; and
generating a data structure comprising the utterance and the context list,
wherein the prompt is generated using: (i) the data structure, and (ii) predefined templates, formatting rules, or a combination thereof.

6. The computer-implemented method of claim 1, wherein:
the generative model comprises a transformer network including multiple layers containing a multi-head, self-attention mechanism and a position-wise, feed-forward network,
the multi-head, self-attention mechanism is configured to enable parallel processing of input sequences from the prompt, allowing the generative model to simultaneously evaluate importance of different segments of the input sequences relative to each other,
the position-wise, feed-forward network includes two linear transformations with a non-linear activation function in between, and
each element of the input sequences, enriched with context including the importance of different segments of the input sequences relative to each other by the multi-head, self-attention mechanism, is processed independently through the position-wise, feed-forward network.

7. The computer-implemented method of claim 1, further comprising displaying the response on a user interface, wherein the utterance is received via the user interface, the user interface is part of an application associated with an AI-powered chatbot system.

8. A system comprising:
one or more processors;
a memory coupled to the one or more processors, the memory storing a plurality of instructions executable by the one or more processors, the plurality of instructions comprising instructions that when executed by the one or more processors cause the one or more processors to perform operations including:
receiving an utterance concerning code in a codebase;
generating an utterance vector embedding based on the utterance;
executing a similarity search on a vector index by comparing the utterance vector embedding to vector embeddings stored in the vector index using a similarity metric and identifying relevant nodes in a graph-based representation of the codebase based on the comparing, wherein each of the vector embeddings stored in the vector index represent parameters or attributes of the code in a continuous vector space, and wherein the parameters or attributes for each of the vector embeddings are associated with a node in the graph-based representation of the codebase;
executing, based on types of constructs associated with the relevant nodes, queries on a graph database to retrieve additional context associated with the relevant nodes, wherein the graph database stores the graph-based representation of the codebase;
generating a prompt comprising the utterance, the relevant nodes, and the additional context associated with the relevant nodes; and
generating, by a generative model, a response to the utterance based on the prompt,
wherein the comparing the utterance vector embedding to the vector embeddings further includes:
calculating the similarity metric between the utterance vector embedding and each of the vector embeddings,
comparing the similarity metric between the utterance vector embedding and each of the vector embeddings to a predetermined similarity threshold,
when the similarity metric is equal to or greater than the predetermined similarity threshold, the node associated with the utterance vector embedding is identified as the relevant node, and
when the similarity metric is less than the predetermined similarity threshold, the node associated with the utterance vector embedding is identified as a non-relevant node.

9. (canceled)

10. The system of claim 8, wherein the operations further include performing an iterative process for each of the relevant nodes, the performing the iterative process including:
analyzing each of the relevant nodes; and
identifying, based on the analyzing, the types of constructs associated with the relevant nodes.

11. The system of claim 10, wherein:
the types of constructs associated with the relevant nodes are node label types;
the queries executed on the graph database are graph queries;
the graph queries are executed for each of the types of constructs associated with the relevant nodes to retrieve the additional context associated with the relevant nodes; and
the additional context includes connected nodes, function invocations, dependencies, and related files.

12. The system of claim 11, wherein the operations further include:
compiling properties or attributes for each of the relevant nodes and connected nodes, the properties or attributes for edges that represent relationships between each of the relevant nodes and the connected nodes in the graph-based representation of the codebase, and the additional context within a context list in association with each of the relevant nodes; and
generating a data structure comprising the utterance and the context list,
wherein the prompt is generated using: (i) the data structure, and (ii) predefined templates, formatting rules, or a combination thereof.

13. The system of claim 8, wherein:
the generative model comprises a transformer network including of multiple layers containing a multi-head, self-attention mechanism and a position-wise, feed-forward network,
the multi-head, self-attention mechanism is configured to enable parallel processing of input sequences from the prompt, allowing the generative model to simultaneously evaluate importance of different segments of the input sequences relative to each other,
the position-wise, feed-forward network includes two linear transformations with a non-linear activation function in between, and
each element of the input sequences, enriched with context including the importance of different segments of the input sequences relative to each other by the multi-head, self-attention mechanism, is processed independently through the position-wise, feed-forward network.

14. The system of claim 8, wherein the operations further include:
displaying the response on a user interface,
wherein the utterance is received via the user interface, the user interface is part of an application associated with an AI-powered chatbot system.

15. A computer-program product tangibly embodied in a non-transitory machine-readable storage medium, including instructions configured to cause one or more data processors to perform operations including:
receiving an utterance concerning code in a codebase;
generating an utterance vector embedding based on the utterance;
executing a similarity search on a vector index by comparing the utterance vector embedding to vector embeddings stored in the vector index using a similarity metric and identifying relevant nodes in a graph-based representation of the codebase based on the comparing, wherein each of the vector embeddings stored in the vector index represent parameters or attributes of the code in a continuous vector space, and wherein the parameters or attributes for each of the vector embeddings are associated with a node in the graph-based representation of the codebase;
executing, based on types of constructs associated with the relevant nodes, queries on a graph database to retrieve additional context associated with the relevant nodes, wherein the graph database stores the graph-based representation of the codebase;
generating a prompt comprising the utterance, the relevant nodes, and the additional context associated with the relevant nodes; and
generating, by a generative model, a response to the utterance based on the prompt,
wherein the comparing the utterance vector embedding to the vector embeddings further includes:
calculating the similarity metric between the utterance vector embedding and each of the vector embeddings,
comparing the similarity metric between the utterance vector embedding and each of the vector embeddings to a predetermined similarity threshold,
when the similarity metric is equal to or greater than the predetermined similarity threshold, the node associated with the utterance vector embedding is identified as the relevant node, and
when the similarity metric is less than the predetermined similarity threshold, the node associated with the utterance vector embedding is identified as a non-relevant node.

16. (canceled)

17. The computer-program product of claim 15, wherein the operations further include performing an iterative process for each of the relevant nodes, the performing the iterative process including:
analyzing each of the relevant nodes; and
identifying, based on the analyzing, the types of constructs associated with the relevant nodes.

18. The computer-program product of claim 17, wherein:
the types of constructs associated with the relevant nodes are node label types;
the queries executed on the graph database are graph queries;
the graph queries are executed for each of the types of constructs associated with the relevant nodes to retrieve the additional context associated with the relevant nodes; and
the additional context includes connected nodes, function invocations, dependencies, and related files.

19. The computer-program product of claim 18, wherein the operations further include:
compiling properties or attributes for each of the relevant nodes and connected nodes, the properties or attributes for edges that represent relationships between each of the relevant nodes and the connected nodes in the graph-based representation of the codebase, and the additional context within a context list in association with each of the relevant nodes; and
generating a data structure comprising the utterance and the context list,
wherein the prompt is generated using: (i) the data structure, and (ii) predefined templates, formatting rules, or a combination thereof.

20. The computer-program product of claim 15, wherein:
the generative model comprises a transformer network including multiple layers containing a multi-head, self-attention mechanism and a position-wise, feed-forward network,
the multi-head, self-attention mechanism is configured to enable parallel processing of input sequences from the prompt, allowing the generative model to simultaneously evaluate importance of different segments of the input sequences relative to each other,
the position-wise, feed-forward network includes two linear transformations with a non-linear activation function in between, and
each element of the input sequences, enriched with context including the importance of different segments of the input sequences relative to each other by the multi-head, self-attention mechanism, is processed independently through the position-wise, feed-forward network.
